(19) United States
(12) Patent Application Publication
(10) Pub. No.: US 2016/0085117 A1
(43) Pub. Date: Mar. 24, 2016

(54) DIRECT BACKLIGHT AND TELEVISION RECEIVER

(71) Applicant: SHARP KABUSHIKI KAISHA, Osaka (JP)

(72) Inventors: Kohji ARAI, Osaka-shi (JP); Shunsaku FUCHIKAWA, Osaka-shi (JP); Tetsuroh KUWABARA, Osaka-shi (JP); Ikuo NAKAMURA, Osaka-shi (JP)

(73) Assignee: SHARP KABUSHIKI KAISHA, Osaka-shi, Osaka (JP)

(21) Appl. No.: 14/889,891

(22) PCT Filed: May 15, 2014
(86) PCT No.: PCT/JP2014/062924

§ 371 Date: Nov. 9, 2015

(30) Foreign Application Priority Data
May 15, 2013 (JP) 2013-103440

(51) Int. Cl. G02F 1/1335; H04N 5/44

(52) U.S. Cl. CPC G02F 1/133611; G02F 1/133603; G02F 1/133608; H04N 5/44

(57) ABSTRACT

A direct backlight includes a substrate having a plurality of light sources provided thereon; an optical member being provided at such a position as to face the light sources; and a supporting pole, fixed in between each adjacent two of the light sources on the substrate, for supporting the optical member, the supporting pole having light transparency, the supporting pole including two surfaces at least some region of which are mirror-finished and which respectively face the each adjacent two of the light sources.

### TECHNICAL FIELD

The present invention relates to (i) a direct backlight and (ii) a television receiver including that direct backlight.

### BACKGROUND ART

Patent Literature 1 discloses an illumination device including (i) a diffusing plate, (ii) a light source for irradiating the diffusing plate with light, the light source including a plurality of light-emitting modules provided above the diffusing plate in a grid pattern and each including a light-emitting element, and (iii) support pins, dotted on the chassis, for supporting the diffusing plate, the support pins being provided on line segments each connecting adjacent ones of the plurality of light-emitting modules to each other. Patent Literature 1 also discloses that a white color is used as the color of the surface of each of the support pins.

### CITATION LIST

### Patent Literature

### [Patent Literature 1]

PCT International Publication WO No. 2010/146895, Pamphlet (Publication Date: Dec. 23, 2010)

### SUMMARY OF INVENTION

### Technical Problem

As a result of diligent examination of the technique of Patent Literature 1, the inventors of the present invention have found that the supporting pins problematically cast their shadows on the diffusing plate.

The present invention has been attained in view of the above problem. A main object of the present invention is to provide a technique for, in a direct backlight including a supporting pole, fixed to a substrate on which light sources are provided, for supporting an optical member provided at such a position as to face the light sources, reducing shadows cast by the supporting pole on the optical member.

### Solution to Problem

In order to attain the above object, a direct backlight according to an aspect of the present invention is a direct backlight including: a substrate having a plurality of light sources provided thereon; an optical member being provided at such a position as to face the light sources; and a supporting pole, fixed in between each adjacent two of the light sources on the substrate, for supporting the optical member, the supporting pole having light transparency, the supporting pole including two surfaces at least some region of which are mirror-finished and which respectively face the each adjacent two of the light sources.

### Advantageous Effects of Invention

According to an aspect of the present invention, a direct backlight including a supporting pole, fixed to a substrate on which light sources are provided, for supporting an optical member provided at such a position as to face the light source, the supporting pole having light transparency and including surfaces at least some region of which are mirror-finished and which respectively face the light sources. With use of the supporting pole, it is possible to reduce shadows cast by the supporting pole on the optical member.

### BRIEF DESCRIPTION OF DRAWINGS

FIG. 1 is an exploded perspective view schematically illustrating a configuration of a display device according to an embodiment of the present invention.

FIG. 2 is perspective views each schematically illustrating respective structures of an LED substrate and a heat spreader joined to the LED substrate in an embodiment of the present invention. (a) of FIG. 2 illustrates the LED substrate and the heat spreader as viewed from a side opposite to a back cabinet, and (b) of FIG. 2 illustrates the LED substrate and the heat spreader as viewed from a back cabinet side.

FIG. 3 is plane views each schematically illustrating respective structures of a portion of the LED substrate and a portion of the heat spreader joined to the LED substrate which portions are near a connector in an embodiment of the present invention. (a) of FIG. 3 illustrates the portions as viewed from a side of one of widthwise ends, (b) of FIG. 3 illustrates the portions as viewed from a side of one of lengthwise ends, and (c) of FIG. 3 illustrates the portions as viewed from the back cabinet 24 side.

FIG. 4 is perspective views each schematically illustrating respective structures of a portion of the LED substrate and a portion of the heat spreader joined to the LED substrate which portions are near the other lengthwise end opposite to the connector, in an embodiment of the present invention. (a) of FIG. 4 illustrates the portions as viewed from the side opposite to the back cabinet, and (b) of FIG. 4 illustrates the portions as viewed from the back cabinet side.

FIG. 5 is perspective views each schematically illustrating respective structures of the LED substrate and the heat spreader in a state of being separated from each other in an embodiment of the present invention. (a) of FIG. 5 illustrates the LED substrate, and (b) of FIG. 5 illustrates the heat spreader.

FIG. 6 is a perspective view schematically illustrating a structure of an interior part of the back cabinet in an embodiment of the present invention.

FIG. 7 is a perspective view illustrating a state in which an LED substrate is fixed to a back cabinet in an embodiment of the present invention.

FIG. 8 is views each partially illustrating how the LED substrate is fixed to the back cabinet in an embodiment of the present invention. (a) of FIG. 8 illustrates a state in which the LED substrate is not fixed, and (b) of FIG. 8 illustrates a state in which the LED substrate is fixed.

FIG. 9 is views each partially illustrating how the LED substrate is fixed to the back cabinet in an embodiment of the present invention. (a) of FIG. 9 illustrates a state in which the LED substrate is not fixed, and (b) of FIG. 9 illustrates a state in which the LED substrate is fixed.

FIG. 10 is views each partially illustrating how the LED substrate is fixed to the back cabinet in an embodiment of the present invention. (a) of FIG. 10 illustrates a state in which the LED substrate is not fixed, and (b) of FIG. 10 illustrates a state in which the LED substrate is fixed.

FIG. 11 is views each partially illustrating how the LED substrate is fixed to the back cabinet in an embodiment of the present invention. (a) of FIG. 11 illustrates a state in which the LED substrate is not fixed, and (b) of FIG. 11 illustrates a state in which the LED substrate is fixed.

FIG. 12 is views each illustrating how the LED substrate is fixed to the back cabinet in an embodiment of the present invention. (a) of FIG. 12 is a perspective view illustrating fixing rib only, (b) of FIG. 12 is a perspective view illustrating a state in which the LED substrate is loosely fitted to the fixing rib, and (c) of FIG. 12 is a perspective view illustrating a state in which the LED substrate is fixed to the fixing rib.

FIG. 13 is top views each illustrating a detailed arrangement of a rib (first protrusion) in an embodiment of the present invention. (a) of FIG. 13 illustrates a relation between the rib (first protrusion) and the LED substrate 22 in a state in which the LED substrate is loosely fitted to the fixing rib, and (b) of FIG. 13 illustrates a relation between the rib (first protrusion) and the LED substrate in a state in which the LED substrate is fixed to the fixing rib.

FIG. 14 is a sectional side view illustrating a detailed arrangement of a rib in an embodiment of the present invention.

FIG. 15 is views each illustrating a detailed arrangement of a rib in an embodiment of the present invention. (a) of FIG. 15 is a plane view illustrating the rib as viewed from a side of the rib which side is opposite to the LED substrate, and (b) is a side view illustrating how the LED substrate is fitted into the rib.

FIG. 16 is views each schematically illustrating a structure of a clip in an embodiment of the present invention. (a) of FIG. 16 is a side view illustrating a single clip, and (b) of FIG. 16 is a perspective view illustrating a state in which the clip is fixed to the LED substrate.

FIG. 17 is a perspective view schematically illustrating a layout of the clip in an embodiment of the present invention.

FIG. 18 is views illustrating comparison between shadows formed on an optical member by a clip according to the conventional technique and the clip according to an embodiment of the present invention. (a) of FIG. 18 is a view illustrating the shadows formed on the optical member by the clip according to the conventional technique, and (b) is a view illustrating the shadows formed on the optical member by the clip according to an embodiment of the present invention.

FIG. 19 is a perspective view illustrating a state in which the clip is fixed to the LED substrate in an embodiment of the present invention.

FIG. 20 is a perspective view illustrating a state in which the clip is fixed to the LED substrate in an embodiment of the present invention.

FIG. 21 is a plane view illustrating a state, in which the clip is fixed to the LED substrate in an embodiment of the present invention, as viewed from the back cabinet side.

FIG. 22 is a side view illustrating a state in which the clip is fixed to the LED substrate in an embodiment of the present invention.

FIG. 23 is a perspective view illustrating a state in which (i) the LED substrate is fixed to the back cabinet and (ii) the clip is fixed to the LED substrate in an embodiment of the present invention.

FIG. 24 is an enlarged perspective view partially illustrating the back cabinet according to an embodiment of the present invention.

FIG. 25 is an enlarged perspective view partially illustrating an outer edge of the back cabinet according to an embodiment of the present invention.

FIG. 26 is a cross-sectional view illustrating the back cabinet as taken along a line A-A illustrated in FIG. 25.

FIG. 27 is an enlarged perspective view partially illustrating the back cabinet 24 and an optical sheet group 17 according to an embodiment of the present invention.

FIG. 28 is enlarged views each partially illustrating an appearance of an upper P chassis according to an embodiment of the present invention. (a) of FIG. 28 is a front view illustrating the upper P chassis, and (b) of FIG. 28 is a perspective view illustrating the upper P chassis.

FIG. 29 is enlarged views each partially illustrating an appearance of a right P chassis according to an embodiment of the present invention. (a) of FIG. 29 is a front view illustrating the right P chassis, and (b) of FIG. 29 is a perspective view illustrating the right P chassis.

FIG. 30 is an enlarged perspective view partially illustrating the back cabinet, the optical sheet group, and the P chassis according to an embodiment of the present invention.

FIG. 31 is a perspective view illustrating the display device according to an embodiment of the present invention, as viewed from a lower side of the display device.

FIG. 32 is a cross-sectional view illustrating the display device as taken along a line B-B illustrated in FIG. 31.

FIG. 33 is a cross-sectional view illustrating the display device as taken along a line C-C illustrated in FIG. 31.

FIG. 34 is a cross-sectional view illustrating the display device as taken along a line D-D illustrated in FIG. 31.

FIG. 35 is a perspective view illustrating a back surface of a front cabinet according to an embodiment of the present invention.

FIG. 36 is a front view illustrating a state in which the optical sheet group is provided on the back cabinet according to an embodiment of the present invention.

FIG. 37 is a front view illustrating a state in which the optical sheet group and the P chassis are provided on the back cabinet according to an embodiment of the present invention.

FIG. 38 is a front view illustrating a state in which the optical sheet group, the P chassis, a liquid crystal panel, and a bezel are provided on the back cabinet according to an embodiment of the present invention.

FIG. 39 is a front view illustrating an appearance of a lower bezel according to an embodiment of the present invention.

### DESCRIPTION OF EMBODIMENTS

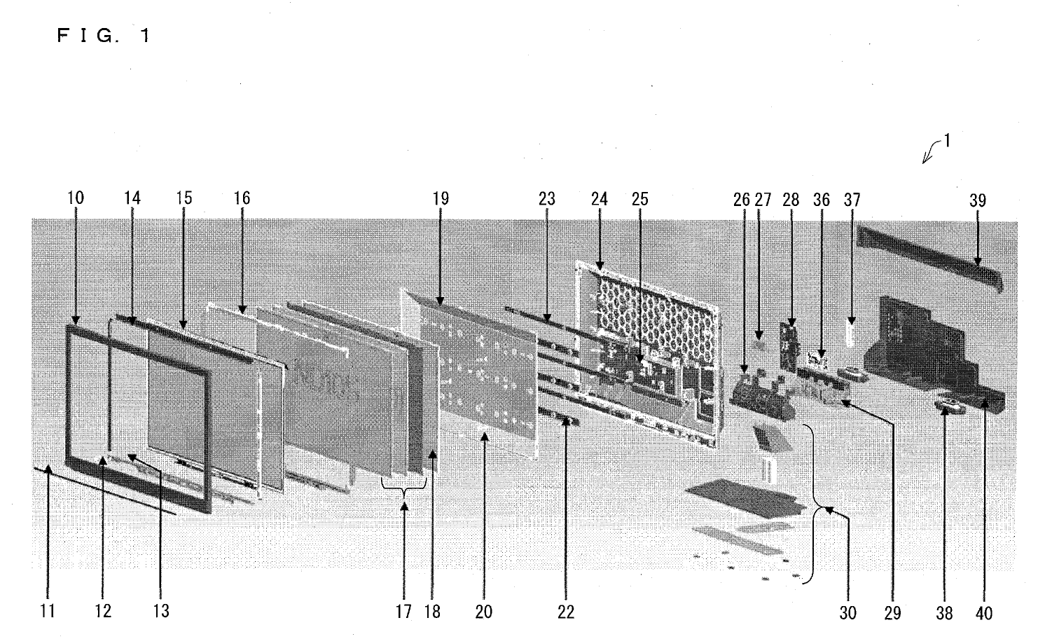

The following discusses a display device according to an embodiment of the present invention with reference to FIGS. 1 through 39. The display device according to the present embodiment can be, for example, a television receiver, but is not limited thereto. Note that, though the following description includes various features (limitations) preferable to put the present invention into practice, the technical scope of the present invention is not limited to descriptions in the embodiment below and the drawings.

(Configuration of Display Device)

FIG. 1 is an exploded perspective view schematically illustrating a configuration of a display device 1 according to an embodiment of the present invention. The display device of the present embodiment is a liquid crystal display device.

As illustrated in FIG. 1, the display device 1 includes a front cabinet 10, a decoration sheet 11, a lamp 12, a remote control circuit 13, a bezel 14, a liquid crystal panel 15, a P chassis 16, an optical sheet group 17, a light diffusing plate 18, a reflection sheet 19, a clip 20, an LED substrate 22, a heat spreader 23, a back cabinet 24, a holder 25, a bottom bracket 26, a support bracket 27, a main circuit 28, a power source circuit 29, a stand 30, an auxiliary circuit 36, a button 37, a speaker 38, a top cover 39, and a bottom cover 40.

The following discusses each of the above members in detail. Note that the following description uses (i) the term “front surface” to refer to that side of the display device 1 on which a display screen is present and (ii) the term “back surface” to refer to that side of the display device 1 which is opposite to the front surface.

(Front Cabinet and Back Cabinet)

The front cabinet 10 is a housing that mainly covers the front surface of the display device 1. The back cabinet 24 is a housing that mainly covers the back surface of the display device 1. Each of the front cabinet 10 and the back cabinet 24 includes, as a main member, an injection-molded product of, for example, plastic.

The display device 1 stores, between the front cabinet 10 and the back cabinet 24, a stack of the bezel 14, the liquid crystal panel 15, the P chassis 16, the optical sheet group 17, the light diffusing plate 18, the reflection sheet 19, the LED substrate 22, and the heat spreader 23 arranged in this order from a front cabinet 10 side.

Respective structures of the front cabinet 10 and the back cabinet 24 will be discussed later in detail as appropriate.

(LED Substrate and Heat Spreader)

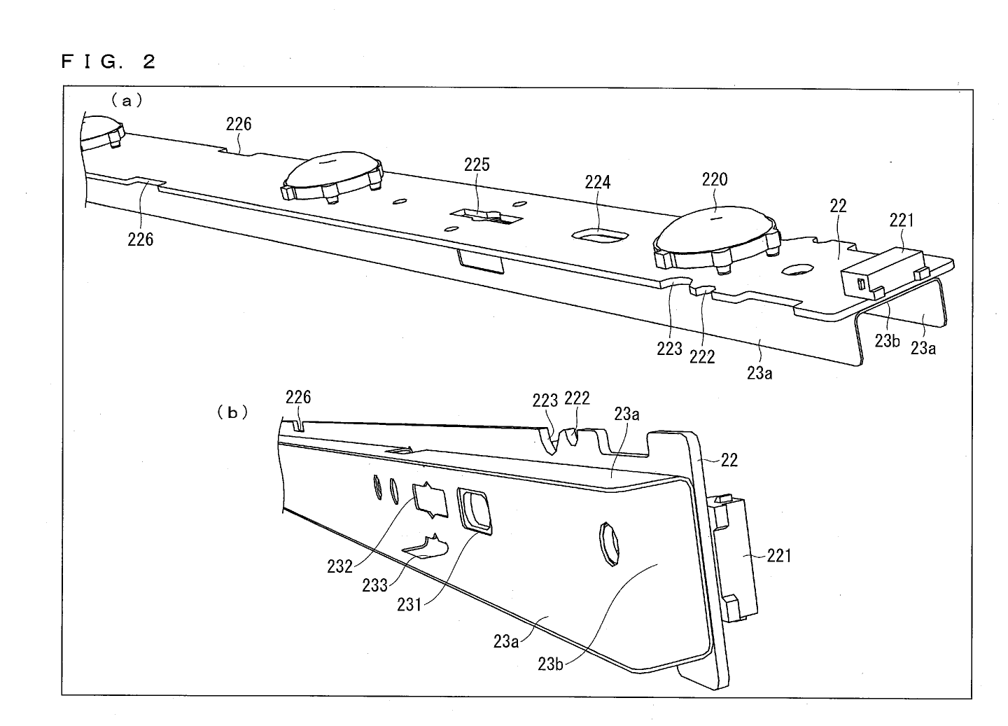

The following discusses the LED substrate (substrate) 22 and the heat spreader (heat dissipating plate) 23 in detail with reference to FIGS. 2 through 5.

FIG. 2 is perspective views each schematically illustrating respective structures of the LED substrate 22 and the heat spreader 23 joined to the LED substrate 22. (a) of FIG. 2 illustrates the LED substrate 22 and the heat spreader 23 as viewed from a side opposite to the back cabinet 24, and (b) of FIG. 2 illustrates the LED substrate 22 and the heat spreader 23 as viewed from a back cabinet 24 side.

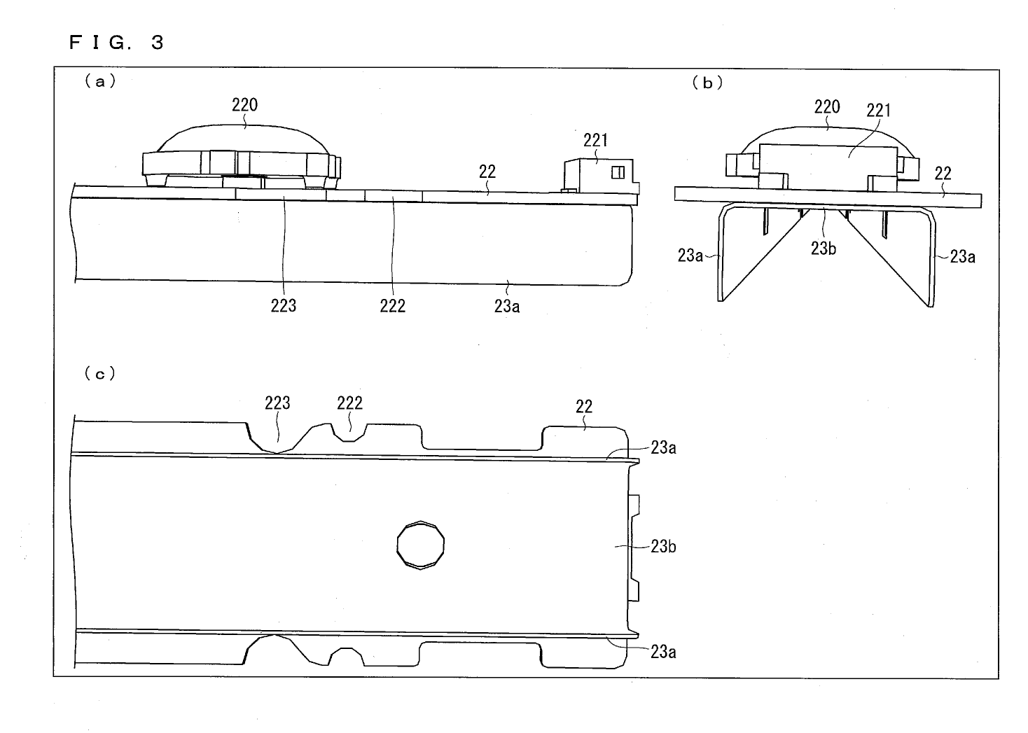

FIG. 3 is plane views each schematically illustrating respective structures of a portion of the LED substrate 22 and a portion of the heat spreader 23 joined to the LED substrate 22 which portions are near a connector 221. (a) of FIG. 3 illustrates the portions as viewed from a side of one of widthwise ends, (b) of FIG. 3 illustrates the portions as viewed from a side of one of lengthwise ends, and (c) of FIG. 3 illustrates the portions as viewed from the back cabinet 24 side.

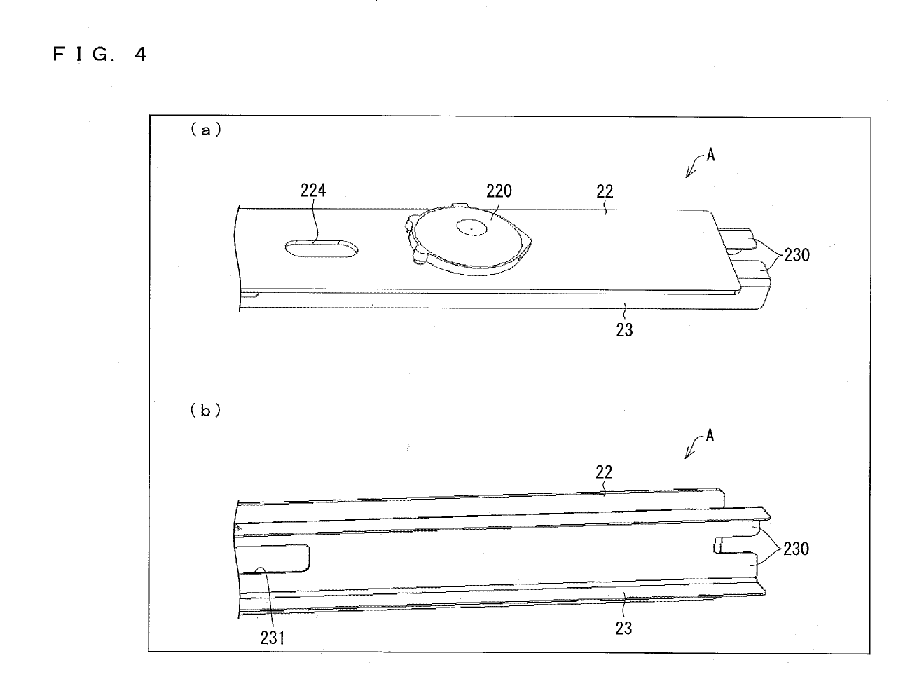

FIG. 4 is perspective views each schematically illustrating respective structures of a portion of the LED substrate 22 and a portion of the heat spreader 23 joined to the LED substrate 22 which portions are near the other lengthwise end opposite to the connector 221. (a) of FIG. 4 illustrates the portions as viewed from the side opposite to the back cabinet 24, and (b) of FIG. 4 illustrates the portions as viewed from the back cabinet 24 side.

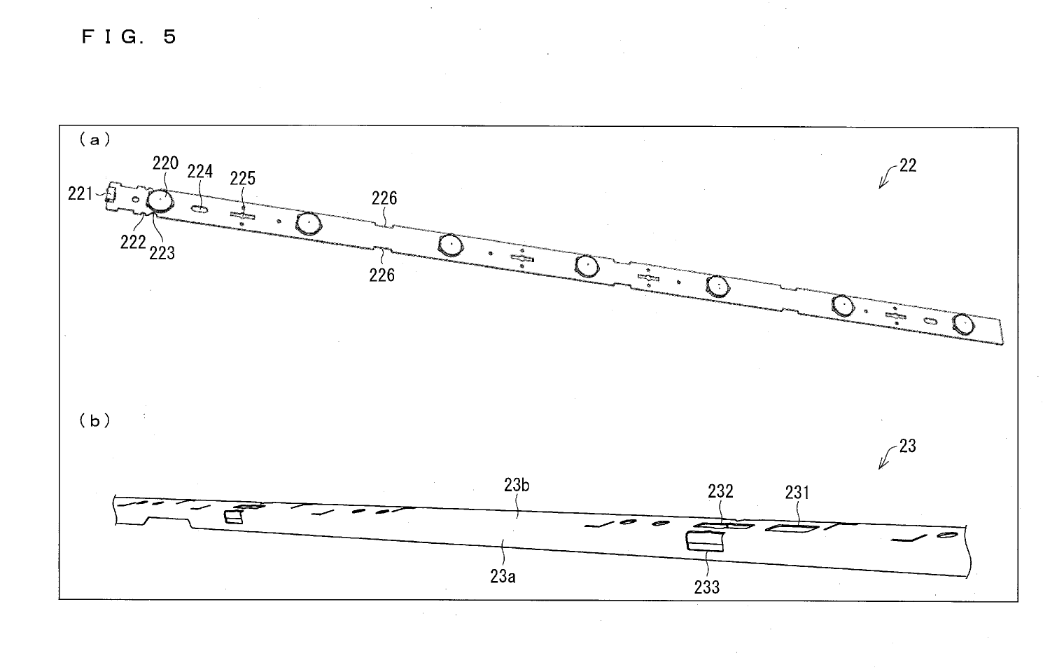

FIG. 5 is perspective views each schematically illustrating respective structures of the LED substrate 22 and the heat spreader 23 in a state of being separated from each other. (a) of FIG. 5 illustrates the LED substrate 22, and (b) of FIG. 5 illustrates the heat spreader 23.

The LED substrate 22 is a substrate which is fixed directly to the back cabinet 24 without using a backlight chassis or the like and includes LED elements (light source) 220 provided on a surface thereof opposite to the back cabinet 24. By fixing the LED substrate 22 directly to the back cabinet 24, it is possible to reduce a component count and simplify an assembly process.

The LED substrate 22 is rectangular in shape and includes a plurality of LED elements 220 aligned in a lengthwise direction thereof. With the LED substrate 22 arranged as described above, it is possible to easily provide the plurality of LED elements 220 in the display device 1.

On one of two lengthwise ends of the LED substrate 22, there is provided the connecter 221 via which the LED substrate 22 is to be electrically connected with the main circuit 28. The LED substrate 22 also includes a circuit (not illustrated) for electrically connecting the connecter 221 with the LED elements 220.

The LED substrate 22 has a plurality of notches and a plurality of openings to have functions which will be described later. That is, a semicircular notch 222 is provided at a widthwise end of the LED substrate 22. A semicircular notch 223 larger than the notch 222 is provided so as to be adjacent to the notch 222. Rectangular notches 226 are provided at corresponding positions on both widthwise ends of the LED substrate 22. Long and narrow openings 224 and 225 extending in the lengthwise direction are provided in a widthwise middle portion of the LED substrate 22.

The heat spreader 23 is a heat dissipating plate having an angular U-shaped widthwise cross section. The heat spreader 23 has a pair of lateral surfaces 23a and a bottom surface 23b. The bottom surface 23b is joined to a surface of the LED substrate 22 on the back cabinet 24 side. With use of the heat spreader 23 having an angular U-shaped widthwise cross section, improvement in heat dissipating efficiency of the LED substrate 22 and prevention of the LED substrate 22 from becoming warped are achieved with a simple configuration. That is, arranging the heat spreader 23 to have an angular U-shaped widthwise cross section increases a surface area of the heat spreader 23 and thus enhances an effect of dissipating heat into air. This makes it possible to improve heat dissipating efficiency of the LED substrate 22 joined to the heat spreader 23. Further, arranging the heat spreader 23 to have the angular U-shaped widthwise cross section enables increasing rigidity of the heat spreader 23 and preventing the LED substrate 22 joined to the heat spreader 23 from becoming warped. This, even in a case where the LED substrate 22 is fixed directly to the back cabinet 24, makes it possible to achieve a sufficient heat dissipating efficiency of the LED substrate 22 and to prevent the LED substrate 22 from becoming warped. This also brings about an effect of reinforcing strength of the back cabinet 24 and allows weight reduction of the heat spreader 23.

The heat spreader 23 is preferably made of a metal or the like that achieves higher heat dissipation than the LED substrate 22. This further improves the heat dissipating efficiency of the LED substrate 22. The heat spreader 23 can be made of, but is not limited to, for example, SPTE.

Further, the heat spreader 23 includes openings provided on the bottom surface 23b at positions corresponding to the openings of the LED substrate 22. That is, an opening 231 identical in shape to the opening 224 is provided at a position directly below the opening 224 of the LED substrate 22, and an opening 232 identical in shape to the opening 225 is provided at a position directly below the opening 225 of the LED substrate 22. Openings 233 are provided on respective lateral surfaces 23a of the heat spreader 23, so as to be adjacent to the opening 232. Functions of these openings will be described later.

Further, the heat spreader 23 may be exposed in part from at least one of the lengthwise ends of the LED substrate 22. In the present embodiment, an exposed portion 230 of the heat spreader 23 is present at the lengthwise end (indicated by “A” in FIG. 4) of the substrate 22 which lengthwise end is opposite to the connector 221 (see FIG. 4). Providing the exposed portion 230 as described above enables the heat spreader 23 to have an increased area that makes contact with air, and thus achieves further improvement in heat dissipating efficiency of the LED substrate 22. Note that the exposed portion 230 has a groove in a midsection thereof. A function of the groove will be described later.

The heat spreader 23 and the LED substrate 22 simply need to be joined to each other in a thermally conductive manner. The heat spreader 23 and the LED substrate 22 can be joined to each other with, for example, a thermal conductive double-sided tape. However, the present embodiment is not limited to this arrangement.

Note that, in a case where the heat spreader 23 is made of an electric conductor such as a metal, an earth potential section of the LED substrate 22 and the heat spreader 23 can be electrically connected with each other. This makes it possible to (i) use, as a path for ground connection of the LED substrate 22, the heat spreader 23 made of an electric conductor, and to (ii) avoid an adverse effect that may occur in a case where the heat spreader 23 made of an electric conductor is electrically floating.

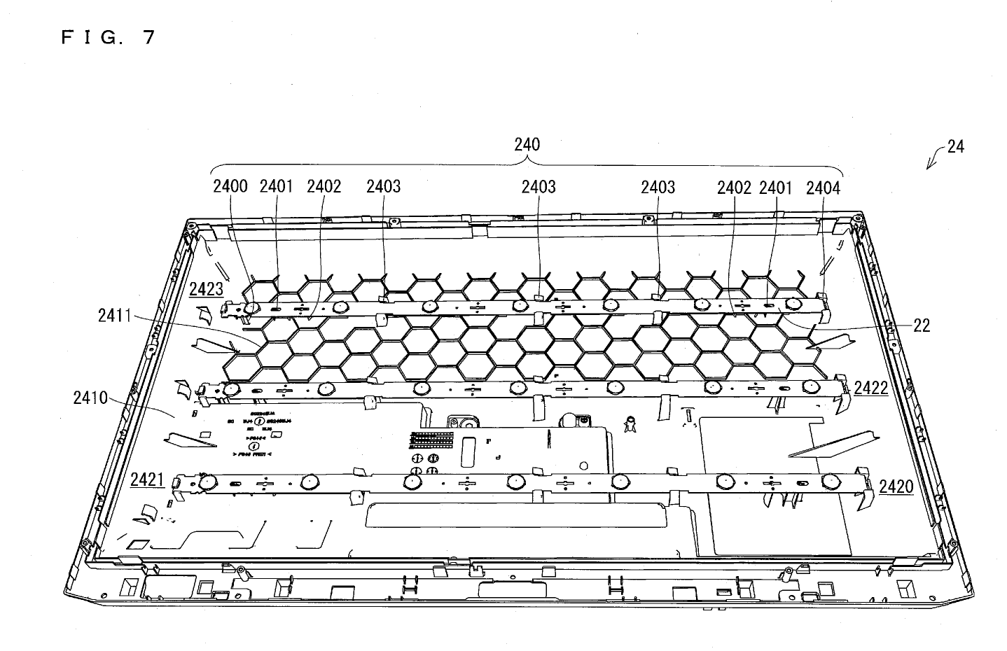

Further, by arranging the LED substrate 22 on a plurality of lines (see FIG. 7), it is possible to obtain a flat-surface light source that can be suitably used as a backlight for a liquid crystal display device.

The present embodiment dealt with an example case in which LED elements are used as a light source. However, the present invention is not limited thereto. Alternatively, the light source can be, for example, a fluorescent tube or the like other than the LED elements.

The present embodiment is arranged such that the longitudinal direction of the LED substrate 22 is parallel with a horizontal direction of the display device 1. However, the present invention is not limited thereto. Alternatively, the LED substrate 22 can be arranged such that, for example, the lengthwise direction of the LED substrate 22 is parallel with a vertical direction of the display device 1.

The number of the LED substrate 22 and the number of light sources to be provided on each LED substrate 22 are not particularly limited.

Note also that “the heat spreader 23 having an angular U-shaped widthwise cross section” as used herein means that an angle between each of the lateral surfaces 23a and the bottom surface 23b is not less than 30 degrees but not more than 150 degrees. The lateral surfaces 23a and the bottom surface 23b are not necessarily flat surfaces, and can be alternatively curved surfaces partially or entirely.

(Fixing LED Substrate to Back Cabinet)

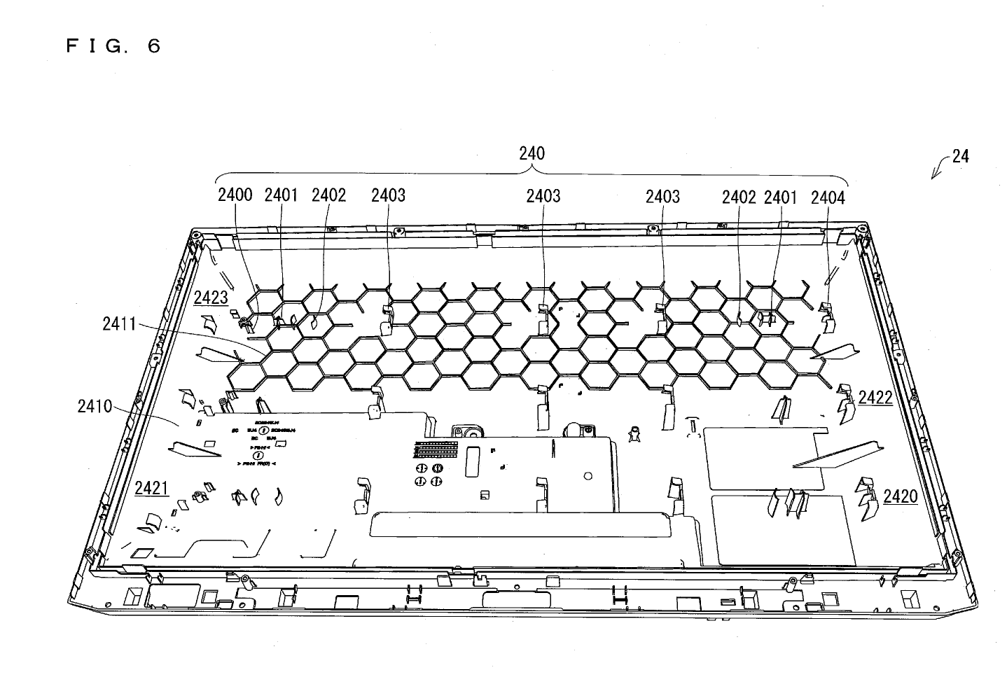

The following discusses in detail fixing of the LED substrate 22 to the back cabinet 24, with reference to FIGS. 6 through 15.

FIG. 6 is a perspective view schematically illustrating a structure of an interior part of the back cabinet 24 (i.e., a part in which the LED substrate 22 and others are present). FIG. 7 is a perspective view illustrating a state in which the LED substrate 22 is fixed to the back cabinet 24. Note that, in FIG. 7, the heat spreader 23 is omitted for ease of viewing.

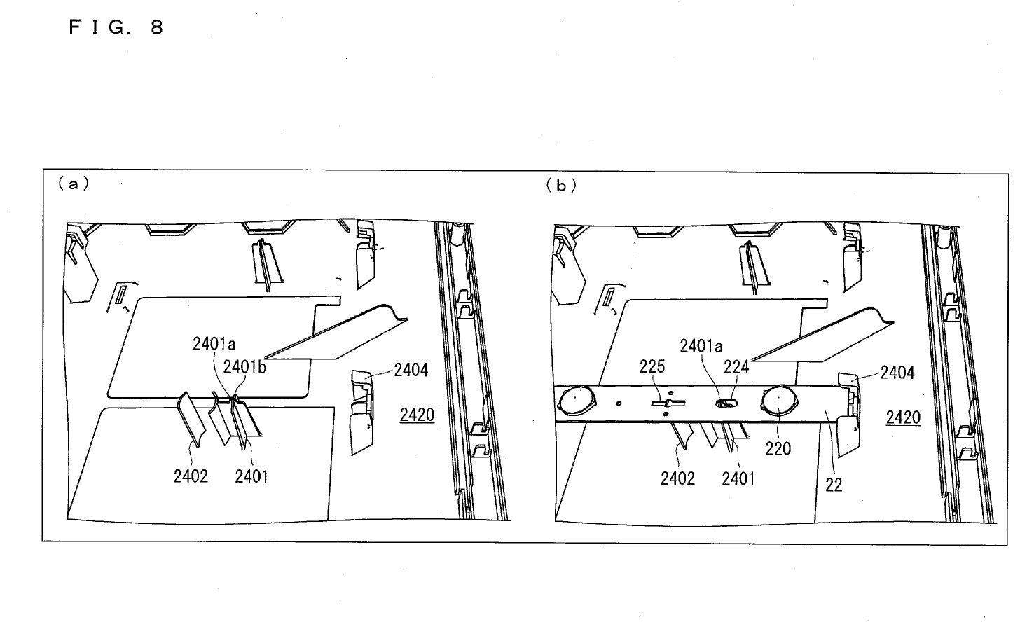

As illustrated in FIGS. 6 and 7, the back cabinet 24 includes a fixing rib 240 for fixing the LED substrate 22. The fixing rib 240 includes different types of ribs having different shapes (ribs 2400 through 2404). FIGS. 8 through 11 illustrate the ribs 2400 through 2404 in detail.

FIG. 8 is views each illustrating how the LED substrate 22 is fixed to the back cabinet 24 in a region 2420 illustrated in FIG. 6. (a) of FIG. 8 illustrates a state in which the LED substrate 22 is not fixed, and (b) of FIG. 8 illustrates a state in which the LED substrate 22 is fixed.

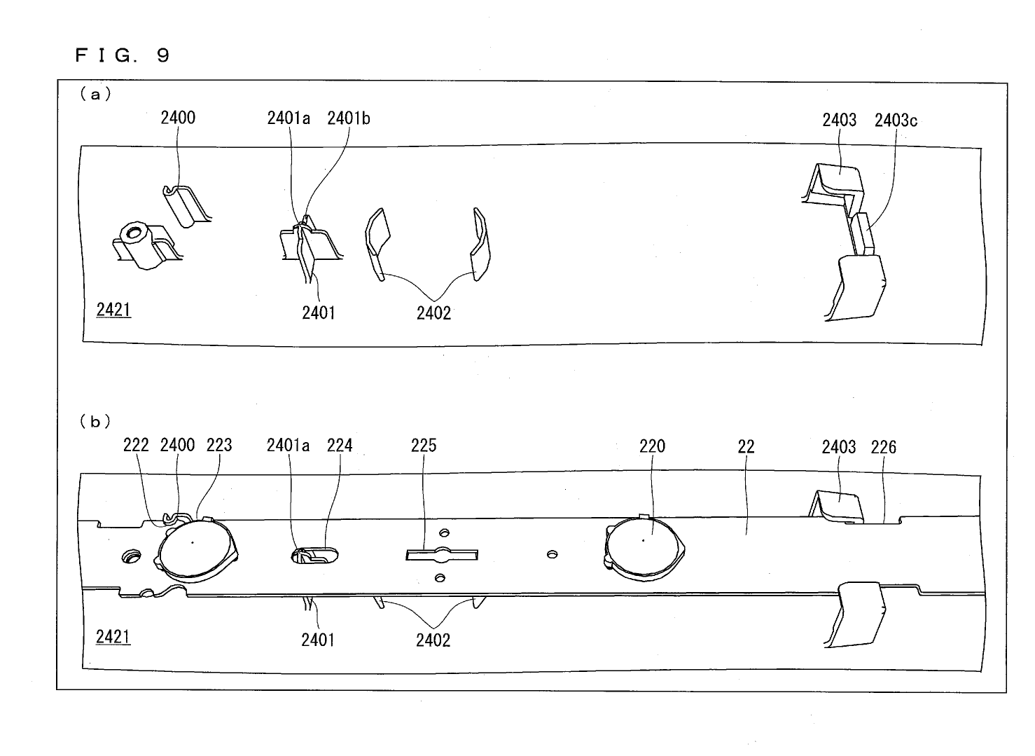

FIG. 9 is views each illustrating how the LED substrate 22 is fixed to the back cabinet 24 in a region 2421 illustrated in FIG. 6. (a) of FIG. 9 illustrates a state in which the LED substrate 22 is not fixed, and (b) of FIG. 9 illustrates a state in which the LED substrate 22 is fixed.

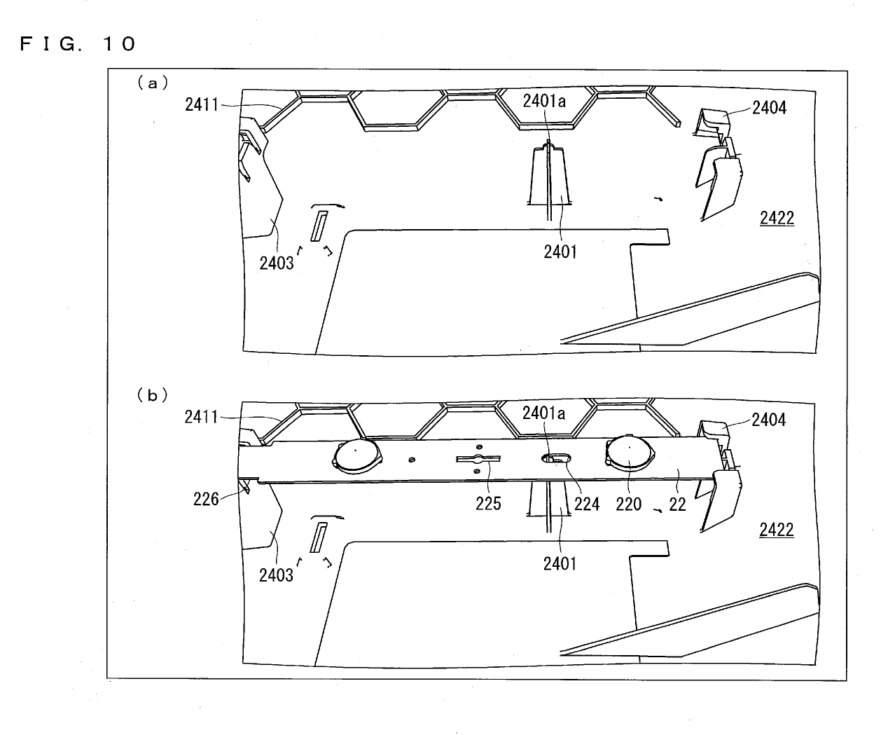

FIG. 10 is views each illustrating how the LED substrate 22 is fixed to the back cabinet 24 in a region 2422 illustrated in FIG. 6. (a) of FIG. 10 illustrates a state in which the LED substrate 22 is not fixed, and (b) of FIG. 10 illustrates a state in which the LED substrate 22 is fixed.

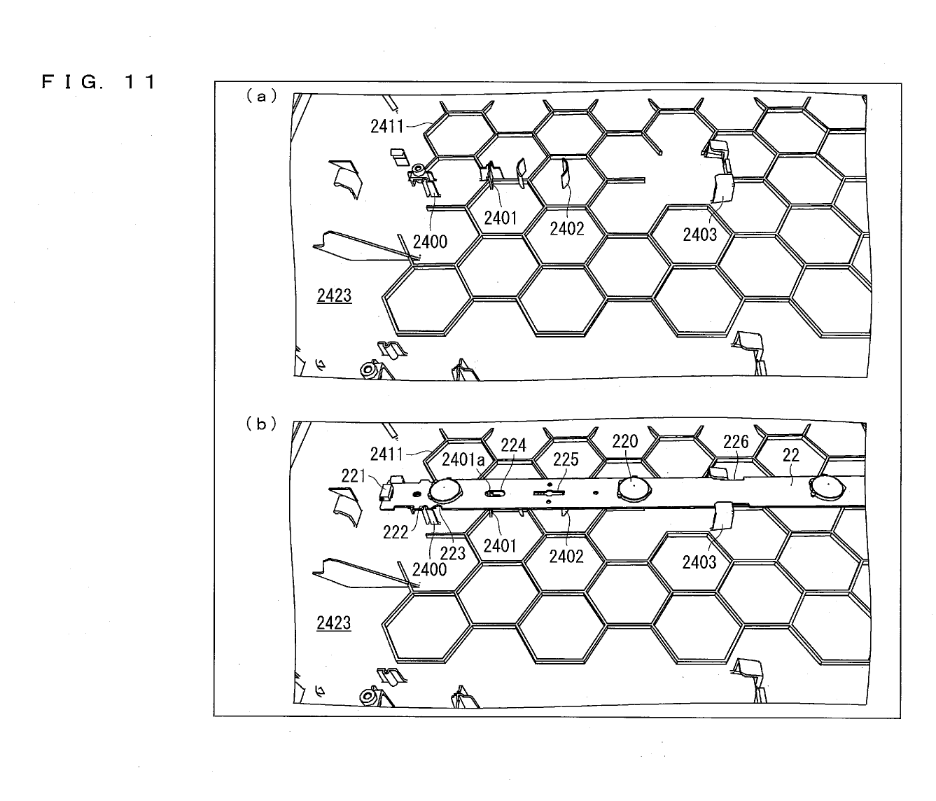

FIG. 11 is views each illustrating how the LED substrate 22 is fixed to the back cabinet 24 in a region 2423 illustrated in FIG. 6. (a) of FIG. 11 illustrates a state in which the LED substrate 22 is not fixed, and (b) of FIG. 11 illustrates a state in which the LED substrate 22 is fixed.

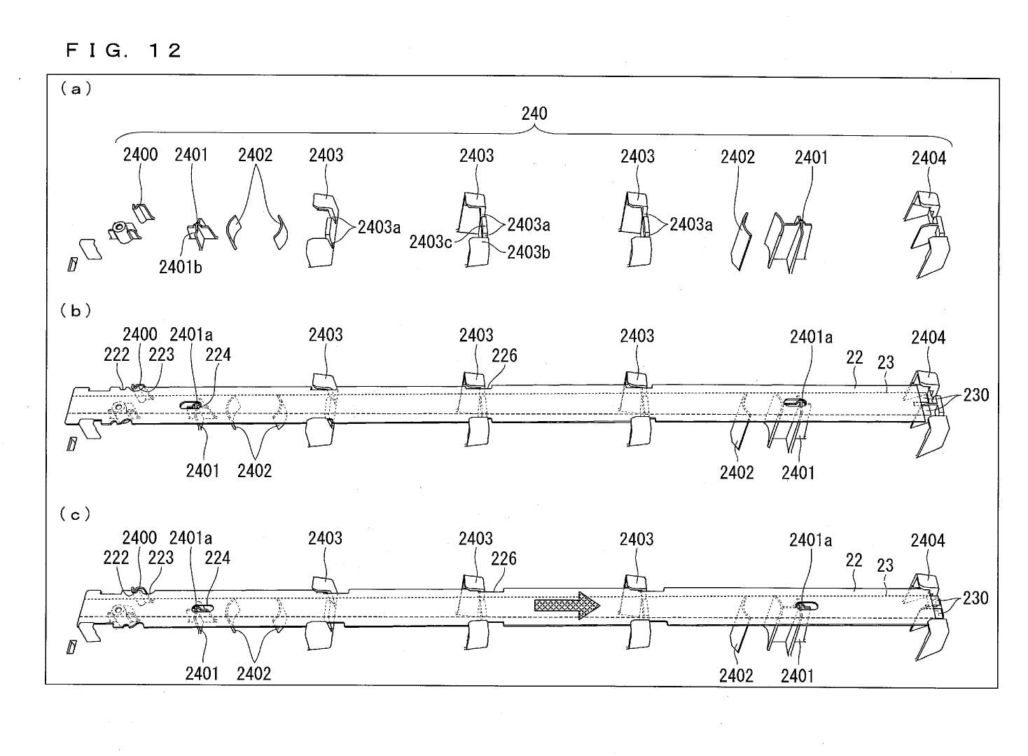

Next, the following discusses a method for fixing the LED substrate 22 to the back cabinet 24, with reference to FIG. 12. (a) of FIG. 12 is a perspective view illustrating the fixing rib 240 only, (b) of FIG. 12 is a perspective view illustrating a state in which the LED substrate 22 is loosely fitted to the fixing rib 240, and (c) of FIG. 12 is a perspective view illustrating a state in which the LED substrate 22 is fixed to the fixing rib 240.

The LED substrate 22 is fixed to the back cabinet 24 in the following manner. That is, as illustrated in (b) of FIG. 12, the LED substrate 22 is first loosely fitted to the fixing rib 240 illustrated in (a) of FIG. 12. In so doing, the LED substrate 22 is still movable in the lengthwise direction of the LED substrate 22. Next, the LED substrate 22 is moved in the lengthwise direction of the LED substrate 22 to a fixing position as illustrated in (c) of FIG. 12, so that the LED substrate 22 is fixed to the back cabinet 24.

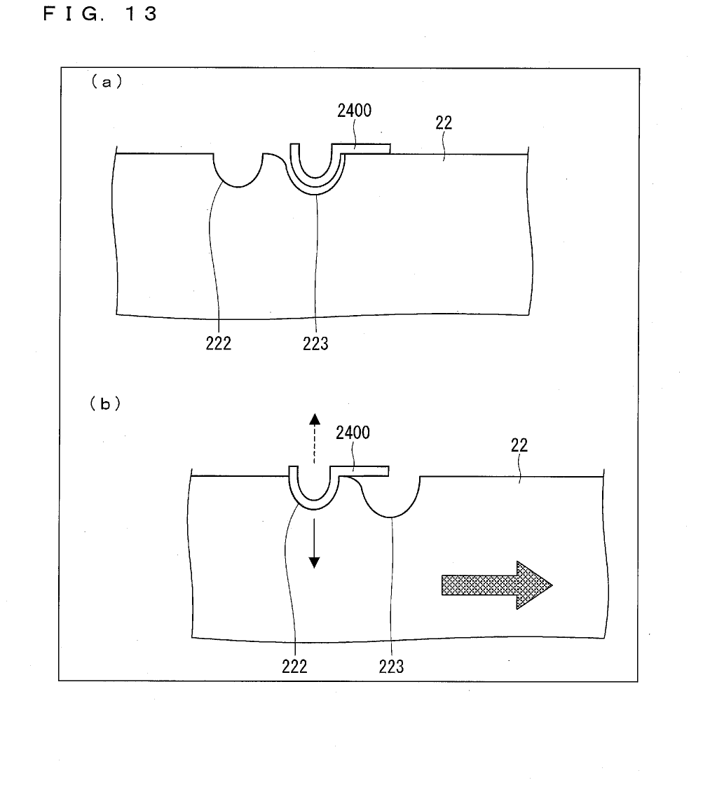

FIG. 13 is top views each illustrating a detailed arrangement of the rib (first protrusion) 2400. (a) of FIG. 13 illustrates a relation between the rib 2400 and the LED substrate 22 in a state in which the LED substrate 22 is loosely fitted to the fixing rib 240, and (b) of FIG. 13 illustrates a relation between the rib 2400 and the LED substrate 22 in a state in which the LED substrate 22 is fixed to the fixing rib 240.

As illustrated in (a) of FIG. 13, the rib 2400 protrudes toward the lengthwise end of the LED substrate 22. While the LED substrate 22 is loosely fitted to the fixing rib 240, the rib 2400 loosely fits to the notch (second notch) 223 of the LED substrate 22 and the LED substrate 22 is movable freely. Then, the LED substrate 22 is moved in its lengthwise direction, so that the rib 2400 fits in the notch (first notch) 222 of the LED substrate 22 as illustrated in (b) of FIG. 13. In so doing, a force directed toward the outside of the LED substrate 22 (in a direction indicated by a dotted arrow in FIG. 13) is exerted on the rib 2400, thereby causing a stress (in a direction indicated by a solid arrow in FIG. 13) to be exerted on the LED substrate 22. This fixes the LED substrate 22 more firmly.

As described above, in the present embodiment, (i) the fixing rib 240 is arranged so as to cause the LED substrate 22 to be loosely fitted to the fixing rib 240 and to fix the LED substrate 22 in a case where the LED substrate 22 is moved to the fixing position in the lengthwise direction of the LED substrate 22, (ii) the rib 2400 protruding toward the widthwise end of the LED substrate 22 is provided, and (iii) the notch 222 which fits in the rib 2400 in a case where the LED substrate 22 is moved to the fixing position is provided at the widthwise end of the LED substrate 22. This arrangement makes it possible to fix the LED substrate 22 to the back cabinet with a simple process, without the need to bend the LED substrate 22, i.e., by loosely fitting the LED substrate 22 to the fixing rib 240 and then moving the LED substrate 22 in the lengthwise direction of the LED substrate 22 to the fixing position. In the present embodiment, the LED substrate 22 is joined to the heat spreader 23 having an angular U-shaped cross section. Thus, it is particularly difficult to bend the LED substrate 22. However, the above arrangement makes it possible to smoothly fix the LED substrate 22 to the back cabinet.

The LED substrate 22 preferably has the notch 223 (i) that is provided so as to be adjacent to the notch 222, (ii) that is larger in size than the notch 222, and (iii) that loosely fits to the rib 2400. This makes it possible to easily cause the LED substrate 22 to be loosely fitted to the fixing rib 240 without causing interference between the rib 2400 and the LED substrate 22.

The rib 2401 has (i) a supporting portion 2401b which supports the LED substrate 22 and (ii) a protrusion (second protrusion) 2401a to be inserted into the opening 224 of the LED substrate 22 (see FIG. 9). The opening 224 is long and narrow and extends in the lengthwise direction of the LED substrate 22, and is preferably oval in shape. The protrusion 2401a is freely movable in the lengthwise direction of the LED substrate 22, and prevent the LED substrate 22 from moving in the widthwise direction of the LED substrate 22. This makes it possible to permit the LED substrate 22 to move in the lengthwise direction of the LED substrate 22, while preventing the LED substrate 22 from moving in other directions. This makes it possible to easily move the LED substrate 22 in the lengthwise direction of the LED substrate 22 and fix the LED substrate 22 at an exact position.

The rib 2402 is a cylindrical rib having notches and supports the LED substrate 22. The notches of the rib 2402 are provided so as to face the lateral surfaces 23a of the heat spreader 23 attached to the LED substrate 22. This makes it possible to avoid interference between the rib 2402 and the heat spreader 23.

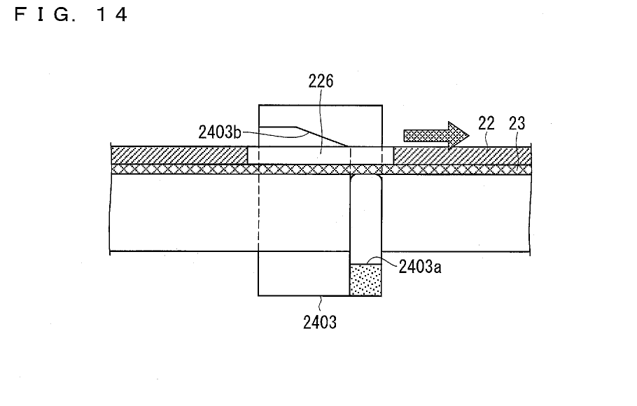

FIG. 14 is a sectional side view illustrating a detailed arrangement of the rib 2403. The rib 2403 has (i) a supporting portion (holding portion) 2403c which supports the LED substrate 22 and (ii) a covering portion (holding portion) 2403b which holds the LED substrate 22 together with the supporting portion 2403c. That is, the LED substrate 22 is held between the supporting portion 2403c and the covering portion 2403b. As illustrated in FIG. 14, the covering portion 2403b is arranged to have an inclination so that a space between the covering portion 2403b and the LED substrate 22 becomes narrower as the LED substrate 22 comes close to the fixing position. With this arrangement, the supporting portion 2403c and the covering portion 2403b hold the substrate 22 therebetween at the fixing position by tightly constricting the LED substrate 22, thereby making it possible to suitably fix the LED substrate 22.

Further, the rib 2403 has grooves 2403a which the lateral surfaces 23a of the heat spreader 23 joined to the LED substrate 22 are to pass through. This makes it possible to (i) avoid interference between the rib 2403 and the heat spreader 23 and (ii) permit the LED substrate 22 to move in the lengthwise direction of the LED substrate 22 while preventing the LED substrate 22 from moving in other directions. This makes it possible to fix the LED substrate 22 at an exact position.

Note that, as illustrated in (b) of FIG. 12, the LED substrate 22 has the notches 226 which allow the LED substrate 22 to pass through the covering portion 2403b, in order that the LED substrate 22 is loosely fitted to the fixing rib 240.

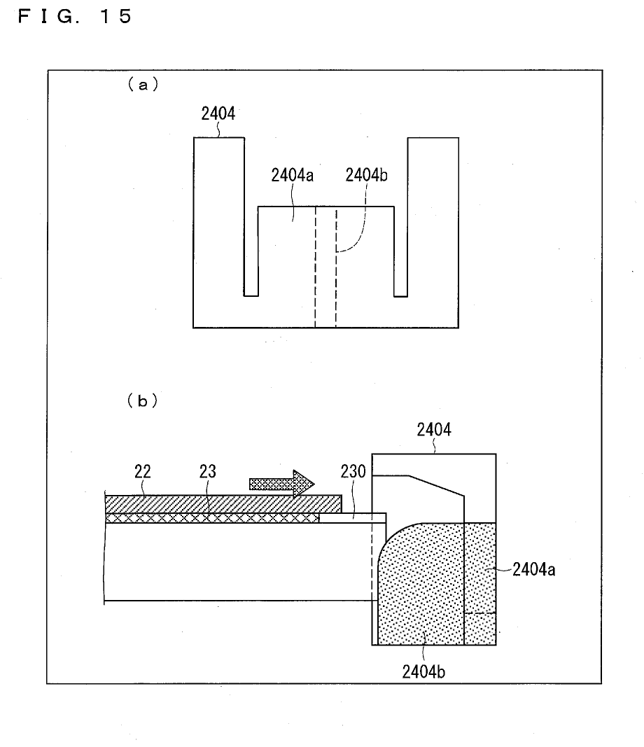

FIG. 15 is views each illustrating a detailed arrangement of the rib 2404. (a) of FIG. 15 is a plane view illustrating the rib 2404 as viewed from a side of the rib 2404 which side is opposite to the LED substrate 22, and (b) of FIG. 15 is a side view illustrating how the LED substrate 22 is inserted into the rib 2404.

As illustrated in (b) of FIG. 15, the exposed portion 230 of the heat spreader 23 joined to the LED substrate 22 is inserted into the rib 2404. The rib 2404 has (i) a pressing portion 2404a which presses the exposed portion 230 from the back cabinet 24 side and (ii) an insertion portion 2404b which is formed in the shape of a plate and extends from a center of the pressing portion 2404a to a LED substrate 22 side. The insertion portion 2404b is to be inserted into the groove formed in the midsection of the exposed portion 230. This makes it possible to properly guide a center position of the LED substrate 22. This makes it possible to fix the LED substrate 22 at an exact position.

In a case where the LED substrate 22 is moved to the fixing position, the pressing portion 2404a pushes up the exposed portion 230 and an end of the LED substrate 22, so that the exposed portion 230 and the end of the LED substrate 22 are pressed by the rib 2404 from front and back sides thereof (see (c) of FIG. 12). With this arrangement, the LED substrate 22 is fixed more firmly.

Similarly to the rib 2403, the rib 2404 has grooves which the lateral surfaces 23a of the heat spreader 23 joined to the LED substrate 22 pass through.

On a display device bottom side (i.e., on a lower side of a paper sheet of FIG. 6), the back cabinet 24 has a structure 2410 (which will be described later) for providing the main circuit 28 and others outside the back cabinet 24 (see FIG. 6). Thus, depths in the interior part of the back cabinet 24 differ from place to place.

For example, the region 2420 of the back cabinet 24 (see FIG. 6) is deep. The region 2421 of the back cabinet 24 is shallow. The region 2422 forms a border between the deep portion and the shallow portion of the back cabinet 24. The region 2423 of the back cabinet 24 is shallow.

However, in order to emit light having no luminance unevenness to the liquid crystal panel 15, it is preferable that the LED substrates 22 are identical in height (note here that a direction from the back cabinet 24 to the front cabinet 10 denotes an upper side). Thus, the ribs 2401 through 2403, each of which serves as a substrate supporting rib which supports the LED substrate 22, are arranged such that the portions (supporting portion 2401b, top surface of the rib 2402, supporting portion 2403c) supporting the LED substrate 22 are flush with each other.

Thus, in the region 2420 which is a deep portion of the back cabinet 24, each of the ribs is arranged to be taller (see FIG. 8). In the region 2421 which is a shallow portion of the back cabinet 24, each of the ribs is arranged to be shorter (see FIG. 9). In a partially deep portion of the region 2422 of the back cabinet 24, each of the ribs is arranged to be taller (see FIG. 10). In the region 2423 in which the back cabinet 24 is shallow, each of the ribs is arranged to be shorter (see FIG. 11).

As such, the portions of the substrate supporting ribs which portions support the LED substrate 22 are arranged to be flush with each other, so that the LED substrates 22 are identical in height. This makes it possible to emit light having no luminance unevenness to the liquid crystal panel 15.

Note that the structure 2410 is provided on the display device bottom side (i.e., on the lower side of the paper sheet of FIG. 6) of the back cabinet 24, so that the back cabinet 24 has sufficient rigidity. In contrast, on a display device upper side (an upper side of the paper sheet of FIG. 6) of the back cabinet 24, a rib 2411 having a honeycomb structure is provided instead of the structure 2410. By arranging the rib 2411 to have a honeycomb structure as described above, it is also possible to make up for rigidity of an upper side of the back cabinet 24.

The above arrangements and locations of the ribs are merely examples and can be altered as appropriate, provided that the ribs enable the LED substrate 22 to be fixed to the back cabinet 24.

(Reflection Sheet)

The reflection sheet 19 is provided between the LED element 220 and the LED substrates 22 and reflects light emitted from the LED element 220. The reflection sheet 19 is not necessarily provided. However, the use of the reflection sheet 19 makes it possible to utilize light to be absorbed into the LED substrate 22 or the back cabinet 24, thereby increasing an amount of light to be emitted to the light diffusing plate 18. Thus, the reflection sheet 19 can increase luminance of the liquid crystal panel 15.

The reflection sheet 19 is made from, for example, polyester typified by expanded polyethylene terephthalate (PET) and the like, and has a light reflecting property.

The reflection sheet 19 can be a sheet that regularly reflects incoming light. However, it is more preferable that the reflection sheet 19 be a sheet that irregularly reflects incoming light. With use of the reflection sheet 19 that irregularly reflects incoming light, reflected light can contain reflection components having an angle that is different from an angle of incidence.

(Clip)

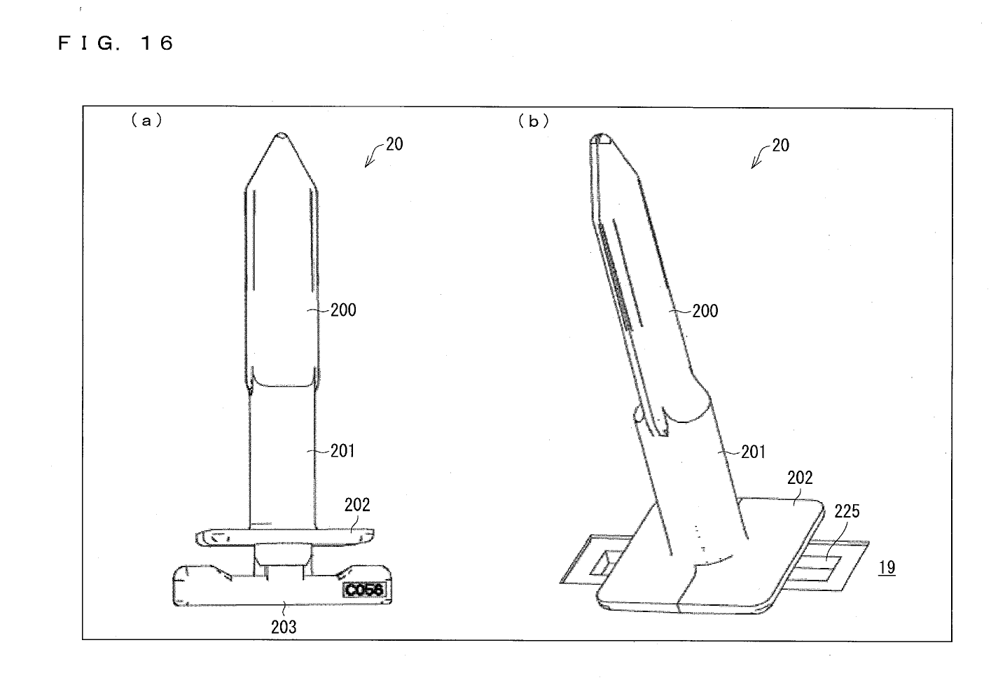

The following discusses the clip (supporting pole) 20 in detail with reference to FIGS. 16 through 22. The clip 20 is a supporting pole for supporting the light diffusing plate (optical member) 18 which is provided at such a position as to face the LED element 220. The clip 20 may be in the shape of a pin that tapers down toward its tip. The clip 20 is arranged to make contact with the light diffusing plate 18 from an LED element 220 side, in order to support the light diffusing plate 18.

FIG. 16 is views each schematically illustrating a structure of the clip 20. (a) of FIG. 16 is a side view illustrating the clip 20 itself, and (b) of FIG. 16 is a perspective view illustrating a state in which the clip 20 is fixed to the LED substrate 22.

As illustrated in (a) of FIG. 16, the clip 20 has (i) a flat plate portion 200 in a shape of a flat plate, (ii) a columnar portion 201 which serves as a base of the flat plate portion 200, (iii) a catch portion 202 connected with a root of the columnar portion 201, and (iv) a through portion 203 connected with the columnar portion 201 so as to be apart from the catch portion 202.

As illustrated in (b) of FIG. 16, the clip 20 is fixed to the LED substrate 22 while the reflection sheet 19 is held between the clip 20 and the LED substrate 22. While the clip 20 is fixed to the LED substrate 22, the through portion 203 is inserted into the opening 225 so as to reach an opposite side of the LED substrate 22, and the through portion 203 and the catch portion 202 together hold the LED substrate 22 and the reflection sheet 19 therebetween.

The clip 20 is made from a material having light transparency. The clip 20 can be made from, for example, transparent resin, though not limited thereto. Further, the flat plate portion 200 is mirror-finished.

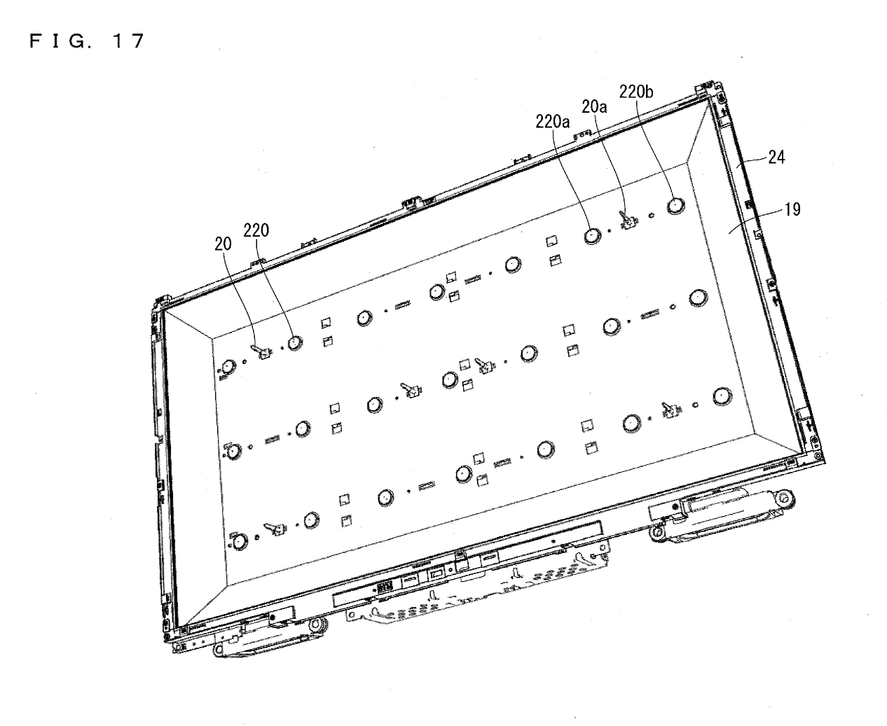

FIG. 17 is a perspective view illustrating a layout of the clip 20. As illustrated in FIG. 17, the reflection sheet 19 is provided on the back cabinet 24 so as to cover the LED substrate 22, and the LED element 220 is exposed on the reflection sheet 19. That is, the reflection sheet 19 is provided between the LED substrate 22 and the LED element 220. The clip 20 is fixed between every two adjacent LED elements 220 (e.g., example, the clip 20 is fixed between an LED element 220a and an LED element 220n which are provided so as to be adjacent to each other). Further, one of two flat surfaces (mirror-finished surfaces) of the flat plate portion 200 faces one of the two LED elements 220 and the other one of the two flat surfaces of the flat plate portion 200 faces the other one of the two LED elements 220.

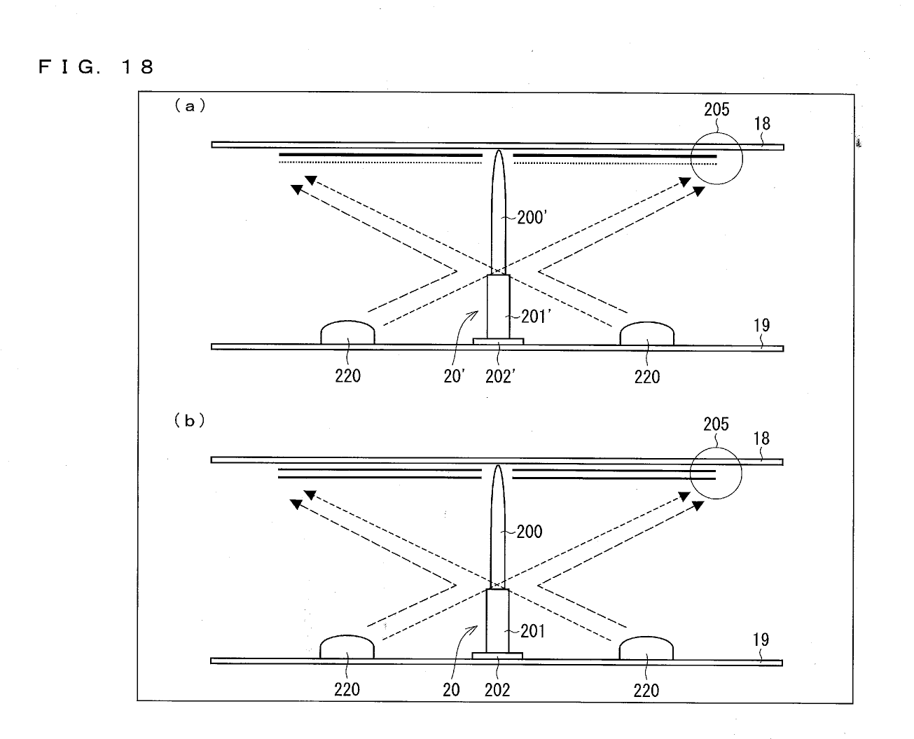

FIG. 18 is views illustrating comparison between shadows formed on the light diffusing plate 18 (optical member) by a clip 20′ according to the conventional technique and by the clip 20 according to the present embodiment. (a) of FIG. 18 is a view illustrating the shadows formed on the light diffusing plate 18 by the clip 20′ according to the conventional technique, and (b) of FIG. 18 is a view illustrating the shadows formed on the light diffusing plate 18 by the clip 20 according to the present embodiment.

The clip 20′ according to the conventional technique has a flat plate portion 200′, a columnar portion 201′, and a catch portion 202′. The flat plate portion 200′ (i) is a highly glossy white portion to increase light reflectance, and (ii) has rough surfaces to realize light diffusion.

In a case where the clip 20′ according to the conventional technique is used, (i) a shadow cast by the clip 20′ which blocks light emitted from the LED element 220 on a left side of the paper sheet of FIG. 18, and (ii) reflection light produced by the clip 20′ reflecting light emitted from the LED element 220 on a right side of the paper sheet of FIG. 18 overlap with each other in a region 205 of the light diffusing plate 18 (see (a) of FIG. 18). In such a case, the shadow is more intense than the reflection light, and thus the shadow remains in the region 205.

In contrast, in a case where the clip 20 according to the present embodiment is used, (i) a shadow cast by the clip 20′ which blocks light emitted from the LED element 220 on the left side of the paper sheet of FIG. 18 and (ii) reflection light produced by the clip 20 reflecting light emitted from the LED element 220 on the right side of the paper sheet of FIG. 18 overlap each other in the region 205 on the light diffusing plate 18 (see (b) of FIG. 18). However, the shadow is less intense due to light transparency of the clip 20, while the reflection light is more intense due to the presence of the mirror-finished region of the flat plate portion 200. Thus, the shadow and the reflection light are cancelled out by each other, and therefore no shadow remains in the region 205.

As such, the above arrangement uses the clip 20 having light transparency and having two surfaces at least some region of which are mirror-finished and which respectively face LED elements 220 provided on both sides of the clip 20. This makes it possible to reduce shadow cast on the optical member by the clip 20.

Note that the clip 20 is not necessarily entirely mirror-finished in a shape of a flat plate. Portions which light indicated by dotted lines in (b) of FIG. 18 does not reach neither need to be in the shape of a flat plate nor need to be mirror-finished. Thus, the clip 20 preferably has, below the mirror-finished flat plate portion 200, the columnar portion 201 which serves as the base of the flat plate portion 200 (see (b) of FIG. 18). This makes it possible to support the flat plate portion 200 having low strength, thus enabling enhancement in strength of the whole clip 20. However, the columnar portion 201 can be omitted.

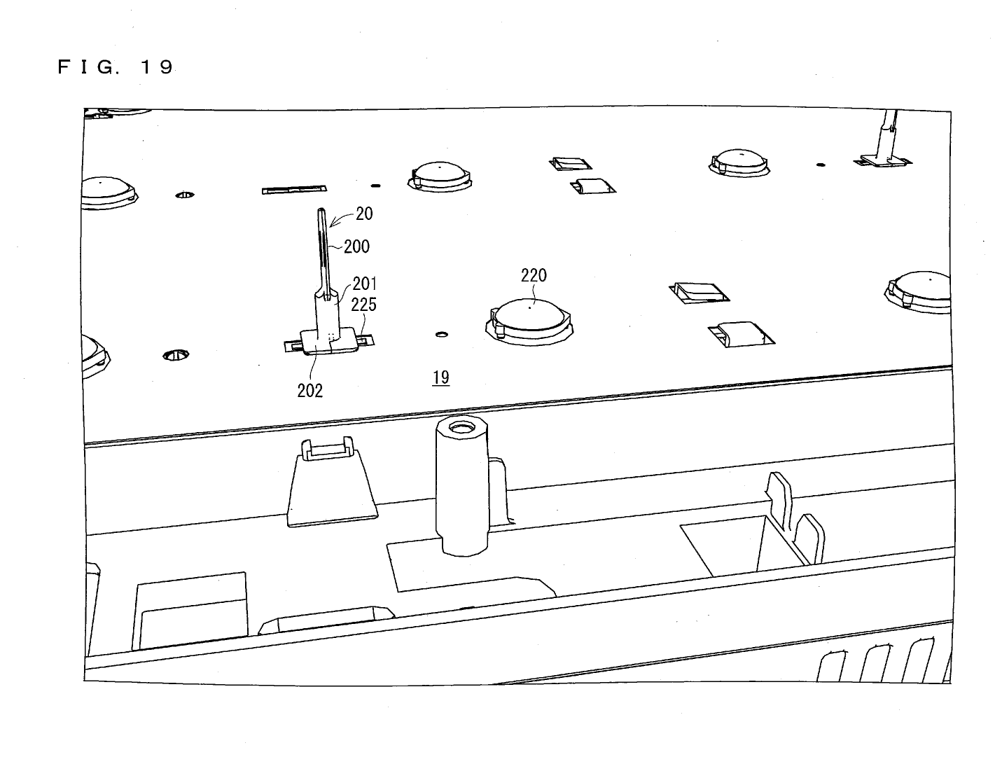

Next, the following discusses in detail fixing of the clip 20 to the LED substrate 22, with reference to FIGS. 19 through 22.

FIG. 19 is a perspective view illustrating a state in which the clip 20 is fixed to the LED substrate 22. Since the LED substrate 22 is covered by the reflection sheet 19, only the opening 225 is visible in FIG. 19. The heat spreader 23 joined to the LED substrate 22 is omitted in FIG. 19.

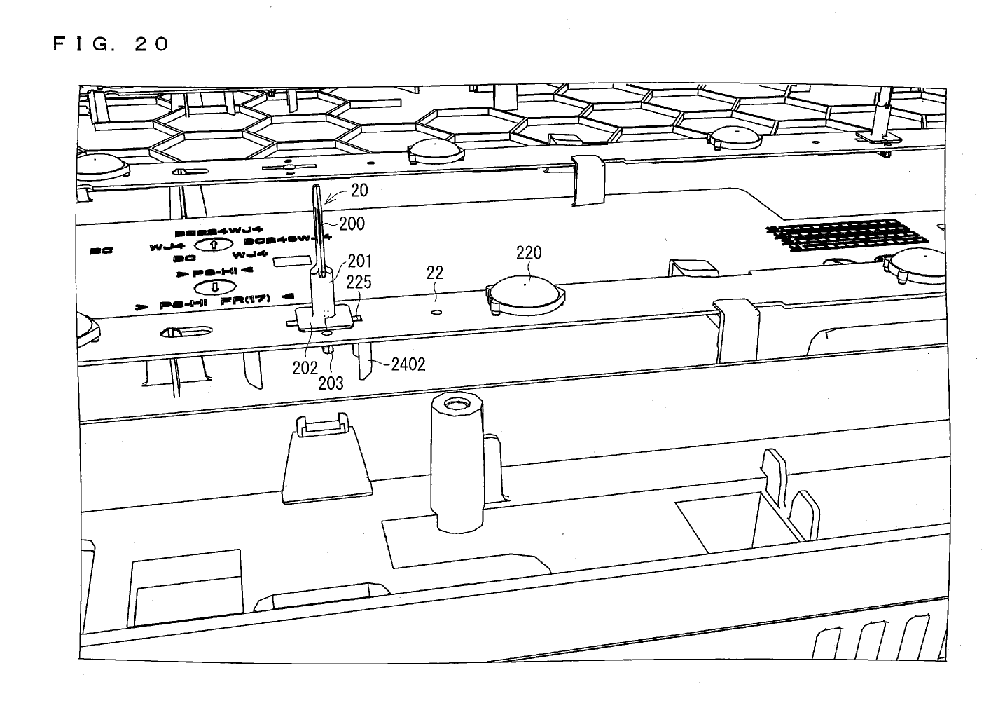

FIG. 20 is a perspective view illustrating a state in which the clip 20 is fixed to the LED substrate 22. In FIG. 20, the reflection sheet 19 and the heat spreader 23 are omitted.

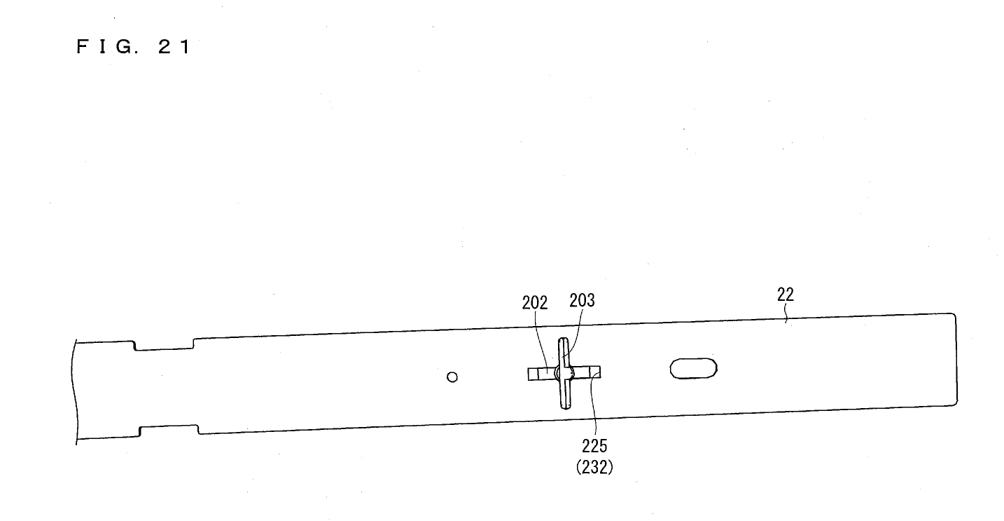

FIG. 21 is a plane view illustrating a state in which the clip 20 is fixed to the LED substrate 22, as viewed from the back cabinet 24 side. In FIG. 21, the heat spreader 23 joined to the LED substrate 22 is omitted.

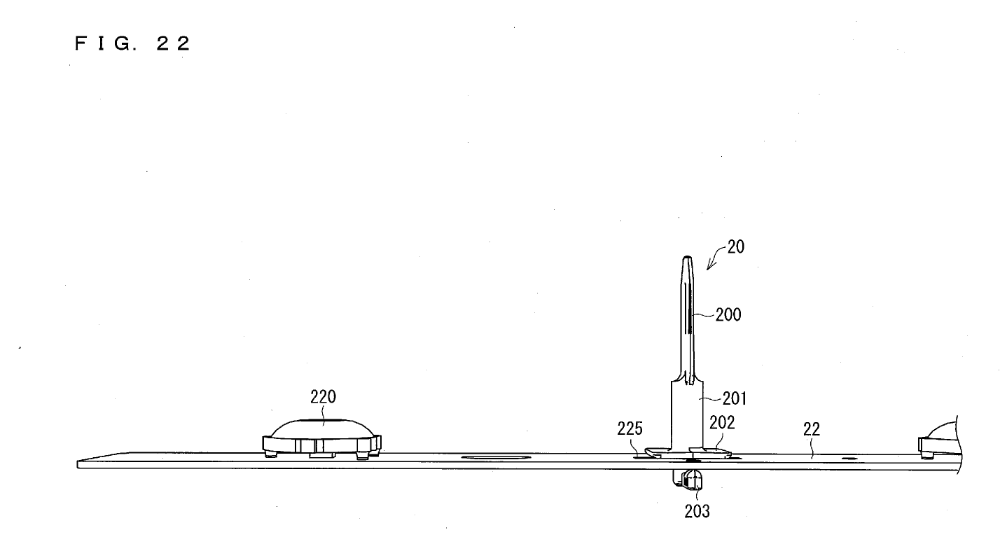

FIG. 22 is a side view illustrating a state in which the clip 20 is fixed to the LED substrate 22. In FIG. 22, the reflection sheet 19 and the heat spreader 23 are omitted.

As illustrated in FIGS. 19 through 22, the clip 20 is fixed to the LED substrate 22, thereby allowing the clip 20 and the LED substrate 22 to hold the reflection sheet 19 therebetween. In this arrangement, the clip 20 fixes the reflection sheet 19 as well. This makes it possible to simplify an assembly process.

The clip 20 simply needs to be fixed to the LED substrate 22. However, it is preferable that the clip 20 be detachably attached to the LED substrate 22. As illustrated in FIGS. 19 through 22, it is also preferable that the clip 20 be fixed to the LED substrate 22 by being caused to penetrate the LED substrate 22 and being twisted.

That is, the through portion 203 is a rod-like member extending so as to be orthogonal to the flat plate portion 20 and the columnar portion 201. The LED substrate 22 has the opening 225 which corresponds to the through portion 203 (note here that the heat spreader 23 also has the opening 232 which corresponds to the opening 225 of the LED substrate 22). Thus, by causing the clip 20 to penetrate the LED substrate 22 in a state such that an orientation of the through portion 203 and an orientation of the opening 232 match each other, it is possible to cause the through portion 203 to reach the opposite side of the LED substrate 22. After the insertion, the clip 20 is twisted by, for example, 90 degrees so that the through portion 203 functions like an anchor as illustrated in FIG. 21. The through portion 203 and the catch portion 202 then hold the LED substrate 22 therebetween, so that the clip 20 is fixed to the LED substrate 22.

As such, the clip 20 is attached to the LED substrate 22 by a simple process. This makes it easy to reuse the clip 20 and to disassemble and dismantle the display device 1 (or a direct backlight).

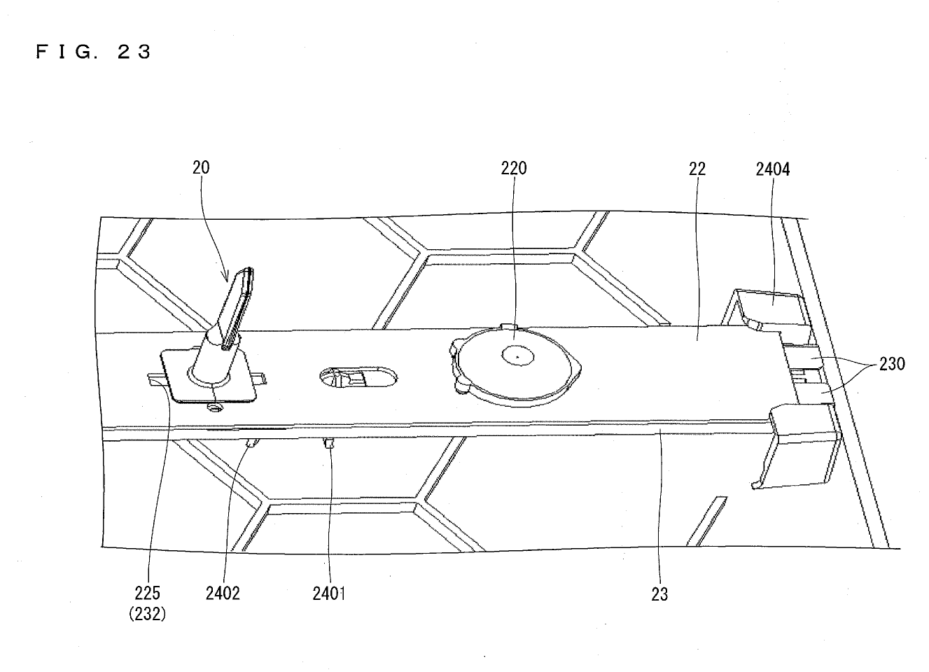

FIG. 23 is a perspective view illustrating a state in which (i) the LED substrate 22 is fixed to the back cabinet 24 and (ii) the clip 20 is fixed to the LED substrate 22.

As illustrated in FIG. 23, a region of the LED substrate 22 in which region the clip 20 is attached is supported by the rib 2402 that is a cylindrical rib having notches. The region concerned is a region to which load is applied in attaching the clip 20 to the region concerned. However, with the arrangement in which the rib 2402 supports the region concerned, it is possible to prevent the LED substrate 22 from bending in attaching the clip 20 to the LED substrate 22. Specifically, by forming the rib 2402 in the shape of a cylinder, it is possible to achieve a high strength. By arranging the rib 2402 to have the notches, it is possible to leave an air flow and to thus enhance an effect of dissipating heat.

As such, with use of the cylindrical rib 2402 (i) having notches and (ii) supporting the region of the LED substrate 22 to which region the clip 20 is attached, it is possible to prevent the LED substrate 22 from bending in attaching the clip 20 to the LED substrate 22, and to enhance the effect of dissipating heat.

Further, by arranging the rib 2402 to have the notches, it is possible to achieve weight reduction.

In order to avoid interference between the through portion 203 of the clip 20 and the heat spreader 23, it is preferable that the heat spreader 23 have the openings 233 provided on the lateral surfaces 23a at the positions corresponding to the openings 232 (see (b) of FIG. 5).

In the present embodiment, the clips 20 are provided on four corners of the reflection sheet 19 and in a center part of the reflection sheet 19 (see FIG. 17). Among these clips 20, for each of the clips 20 provided in the center part of the reflection sheet 19, the rib 2402 supporting the region in which the clip 20 is to be attached can be omitted. This is because the rib 2403 is provided in the center part of the reflection sheet 19 so as to be adjacent to the region in which the clip 20 is to be attached, so that the LED substrate 22 is sufficiently supported. In contrast, since the rib 2403 or the like is not provided on the four corners, it is preferable to provide the rib 2402 on each of the four corners. Note that the above layout of the clips 20 is merely an example and can be altered as appropriate, provided that the light diffusing plate 18 is successfully supported.

(Light Diffusing Plate and Optical Sheet Group)

The light diffusing plate (optical member) 18 and the optical sheet group 17 (i) prevent unevenness in amount of light (i.e., luminance unevenness) emitted by the LED elements 220 and (ii) collects the light emitted by the LED elements 220 and emits the light thus collected toward the liquid crystal panel 15.

Note that the light diffusing plate 18 and the optical sheet group 17 are not necessarily required. However, the arrangement in which the light diffusing plate 18 and the optical sheet group 17 are used, it is possible to prevent luminance unevenness which occurs on the liquid crystal panel 15, as compared to the arrangement in which the light emitted by the LED element 220 simply enters the liquid crystal panel 15.

The optical sheet group 17 is arranged to include, for example, a diffusing sheet, a prism sheet, and a microlens sheet. The number of sheets constituting the optical sheet group 17 and a combination of the sheets are not particularly limited, provided that they achieve intended optical properties. Further, the light diffusing plate 18 is not necessarily provided. In such an arrangement, the optical member supported by the clip 20 is any one sheet of the optical sheet group 17.

In the present embodiment, the direct backlight is constituted by the LED substrate 22, the LED element 220, the reflection sheet 19, the clips 20, the light diffusing plate (optical member) 18, and the optical sheet group 17.

(Bezel, Liquid Crystal Panel, and P Chassis)

The bezel 14 is provided so as to cover a periphery of the liquid crystal panel 15 from an image display surface side of the liquid crystal panel 15. The bezel 14, together with the P chassis 16 (chassis), hold the liquid crystal panel 15, thereby determining a position of the liquid crystal panel 15 in a direction of the normal to the back cabinet 24.

The P chassis 16 is a light blocking member which prevents light from leaking from a periphery of the optical sheet group 17. Further, the P chassis 16 is a member for supporting the liquid crystal panel 15, and the P chassis 16, together with the bezel 14, hold the liquid crystal panel 15, as described above.

Further, the P chassis 16, together with the back cabinet 24, holds the optical sheet group 17, thereby determining a position of the optical sheet group 17 in the direction of the normal to the back cabinet 24.

The bezel 14 and the P chassis 16 each include a Poron (registered trademark) (cushioning member) on a portion by which the liquid crystal panel 15 is held and on a portion by which the optical sheet group 17 is held, respectively. Thus, the bezel 14 and the P chassis 16 can hold the liquid crystal panel 15 and the optical sheet group 17, without making scratches on the liquid crystal panel 15 and the optical sheet group 17.

Note that (i) the determination of the position of the liquid crystal panel 15 by the bezel 14 and the P chassis 16, and (ii) the determination of the position of the optical sheet group 17 by the P chassis 16 and the back cabinet 24 will be described later in detail with different drawings.

(Main Circuit and Power Source Circuit)

The main circuit 28 is a circuit for carrying out centralized control of operations performed in the sections included in the display device 1, and is arranged to include, for example, a central processing unit (CPU). The power source circuit 29 accepts power supply from an external power source and controls power supply with respect to each of the sections included in the display device 1.

The main circuit 28 and the power source circuit 29 are provided on a back surface (a surface opposite to a surface on which the liquid crystal panel 15 is provided) of the back cabinet 24, together with the stand 30, the auxiliary circuit 36, the button 37, and the speaker 38. Further, the main circuit 28, the power source circuit 29, and the like provided on the back surface of the back cabinet 24 are protected by the top cover 39 and the bottom cover 40.

[Double Rib Structure]

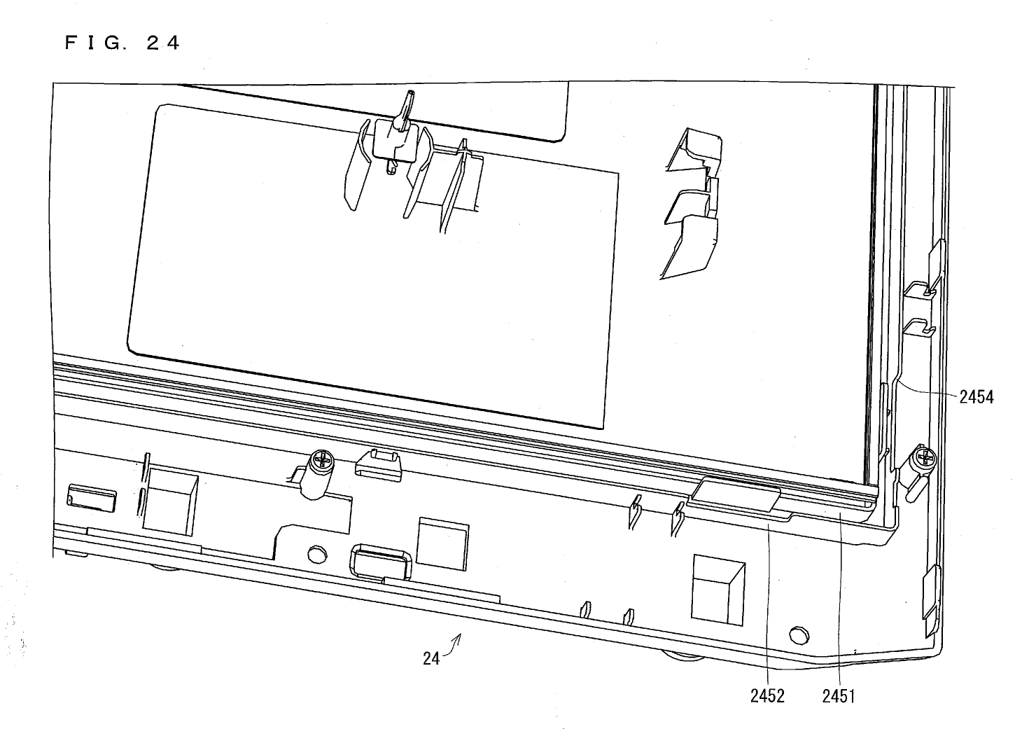

Next, an arrangement for regulating the position of the optical sheet group 17 (optical sheet), in the back cabinet 24, is discussed below with reference to FIGS. 24 through 26. FIG. 24 is an enlarged perspective view partially illustrating the back cabinet 24 according to the present embodiment.

On the back cabinet 14, two ribs (hereinafter, also referred to simply as a “double rib structure”) which regulate the position of the optical sheet group 17 are provided along an outer edge of the back cabinet 24 (see FIG. 24).

Specifically, the back cabinet 14 has (i) an inner rib 2451 which regulates the position of the optical sheet group 17 in the normal direction of the back cabinet 24 and (ii) an outer rib 2452 which regulates the position of the optical sheet group 17 in a direction vertical to the normal direction of the back cabinet 24.

(Details of Double Rib Structure)

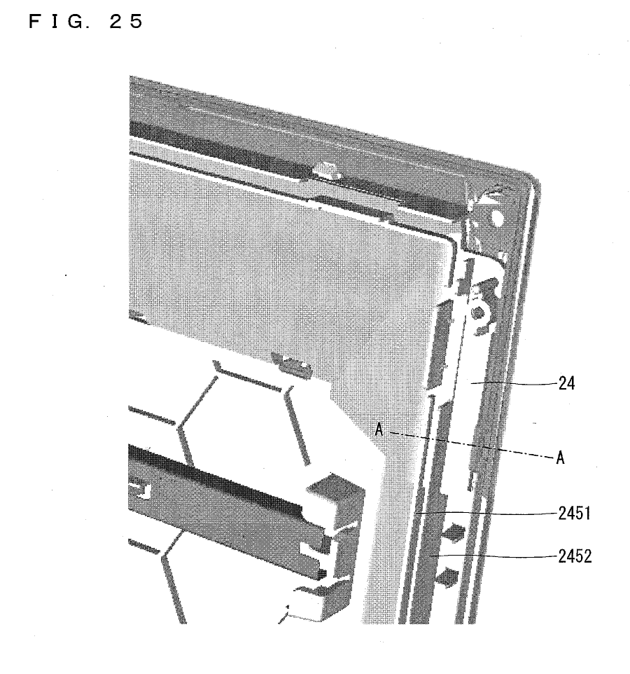

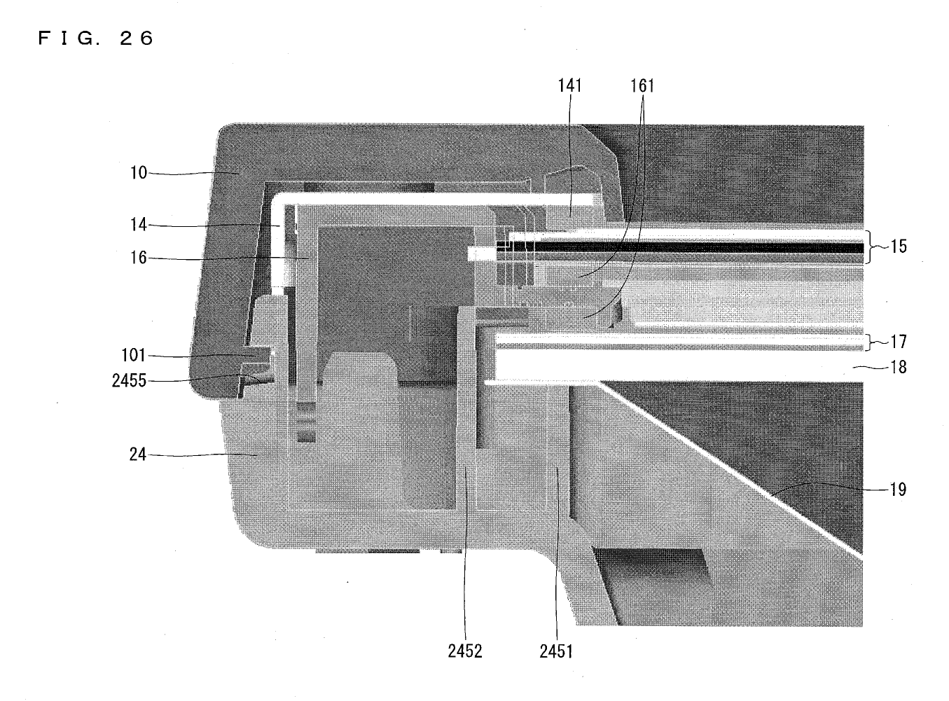

The following discusses the double rib structure in detail with reference to FIGS. 25 and 26. FIG. 25 is an enlarged perspective view partially illustrating the outer edge of the back cabinet 24 according to the present embodiment. FIG. 26 is a cross-sectional view illustrating the back cabinet 24 as taken along a line A-A illustrated in FIG. 25. Note that, for simplification of description, FIG. 25 illustrates an appearance of the back cabinet 24 as viewed from the front cabinet 10 side.

(Inner Rib)

As illustrated in FIG. 26, the inner rib 2451 is provided so that an edge of the inner rib 2451 comes into contact with a surface of the optical sheet group 17 via the reflection sheet 19 and the light diffusing plate 18. On the inner rib 2451, the optical sheet group 17 is provided so as to be stacked on the reflection sheet 19 and the light diffusing plate 18. With this arrangement, the inner rib 2451 regulates the position of the optical sheet group 17 in the normal direction of the back cabinet 24.

Further, the inner rib 2451, together with the P chassis 16 (more specifically, together with a Poron 161 of the P chassis 16), holds the optical sheet group 17 via the reflection sheet 19 and the light diffusing plate 18. Note that the Poron 161 is preferably provided on the P chassis 16 at such a position as to face the inner rib 2451. This allows the Poron 161, together with the inner rib 2451, to effectively hold the optical sheet group 17. The P chassis will be discussed later in detail.

(Outer Rib)

As illustrated in FIG. 26, the outer rib 2452 is arranged so as to be taller than the inner rib 2451. Specifically, the outer rib 2452 is provided so that a lateral surface of the outer rib 2452 comes into contact with an edge of the optical sheet group 17. This makes it possible to regulate a slide of the optical sheet group 17 with use of the lateral surface of the outer rib 2452 even in a case where the optical sheet group 17 provided on the inner rib 2451 slides in the direction vertical to the normal direction of the back cabinet 24.

As such, in a case where the back cabinet 24 is arranged to have the double rib structure, it is possible to efficiently determine the position of the optical sheet group 17 in relation to the back cabinet 24. The double rib structure also makes it possible to achieve a high strength of the back cabinet 24 itself. Thus, even in a case where the display device 1 does not include a backlight chassis, it is possible to achieve a high strength of the display device 1.

Further, the outer rib 2452 has a notch 2454 as illustrated in FIG. 24. The notch 2454 of the outer rib 2452 can be one notch or may be a plurality of notches.

Thanks to the notch 2454 of the outer rib 2452, removal of the optical sheet group 17 provided on the back cabinet 24 can be made by inserting a finger or a thumb into the notch 2454. This makes it possible to easily remove the optical sheet group 17 from the back cabinet 24, even in a case where the outer rib 2452 taller than the optical sheet group 17, which is provided on the inner rib 2451, is provided.

[Fixing of Optical Sheet Group]

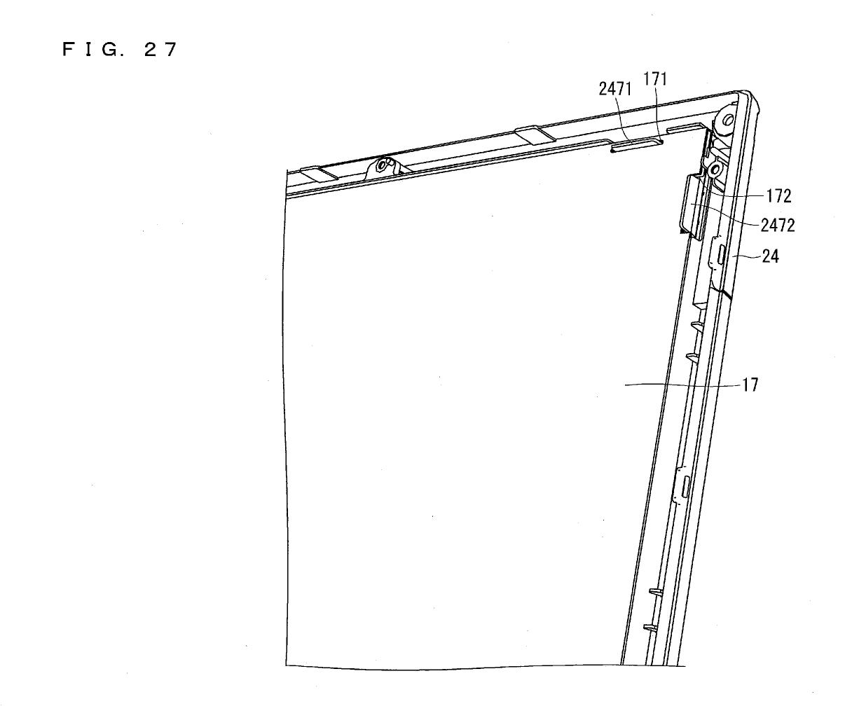

Next, the following discusses fixing of the optical sheet group 17 to the back cabinet 24 in detail with reference to FIGS. 27 through 30. FIG. 27 is an enlarged perspective view partially illustrating the back cabinet 24 and the optical sheet group 17 according to the present embodiment.

(Optical Sheet Group, Back Cabinet)

As illustrated in FIG. 27, the optical sheet group 17 has an opening 171 provided along an outer edge of the optical sheet group 17. The optical sheet group 17 also has a notch 172 provided along the outer edge of the optical sheet group 17. Note that FIG. 27 illustrates a portion (right-upper portion) of the back cabinet 24 and a portion (right-upper portion) of the optical sheet group 17. However, in the present embodiment, the opening 171 and the notch 172 are a plurality of openings and a plurality of notches, respectively, provided along the outer edge of the optical sheet group 17.

The back cabinet 24 has protruding ribs 2471 to be inserted into the respective openings 171 of the optical sheet group 17. The protruding ribs 2471 are provided at positions corresponding to the respective openings 171 of the optical sheet group 17. Further, the back cabinet 24 has protruding ribs 2472 to be fit with the respective notches 172 of the optical sheet group 17. The protruding ribs 2472 are provided at positions corresponding to the respective notches 172 of the optical sheet group 17.

By providing the optical sheet group 17 so that the protruding ribs 2471 of the back cabinet 24 are inserted into the respective openings 171, it is possible to easily fix the position of the optical sheet group 17 in the direction vertical to the normal direction of the back cabinet 24. Further, by arranging the optical sheet group 17 so that the protruding ribs 2472 of the back cabinet 24 fit with the respective notches 172, it is possible to more easily fix the position of the optical sheet group 17 in the direction vertical to the normal direction of the back cabinet 24.

In the present embodiment, the positions of the openings 171 of the optical sheet group 17 (i) are vertically and horizontally asymmetrical and are not 180 degrees rotational symmetric with respect to, as a rotational axis, the normal direction of the optical sheet group 17. This makes it possible to (i) prevent the optical sheet group 17 from being accidentally placed right and left reversed or upside down, and (ii) prevent the optical sheet group 17 from being accidentally placed in such a manner that the optical sheet group 17 is rotated by 180 degrees.

(P Chassis)

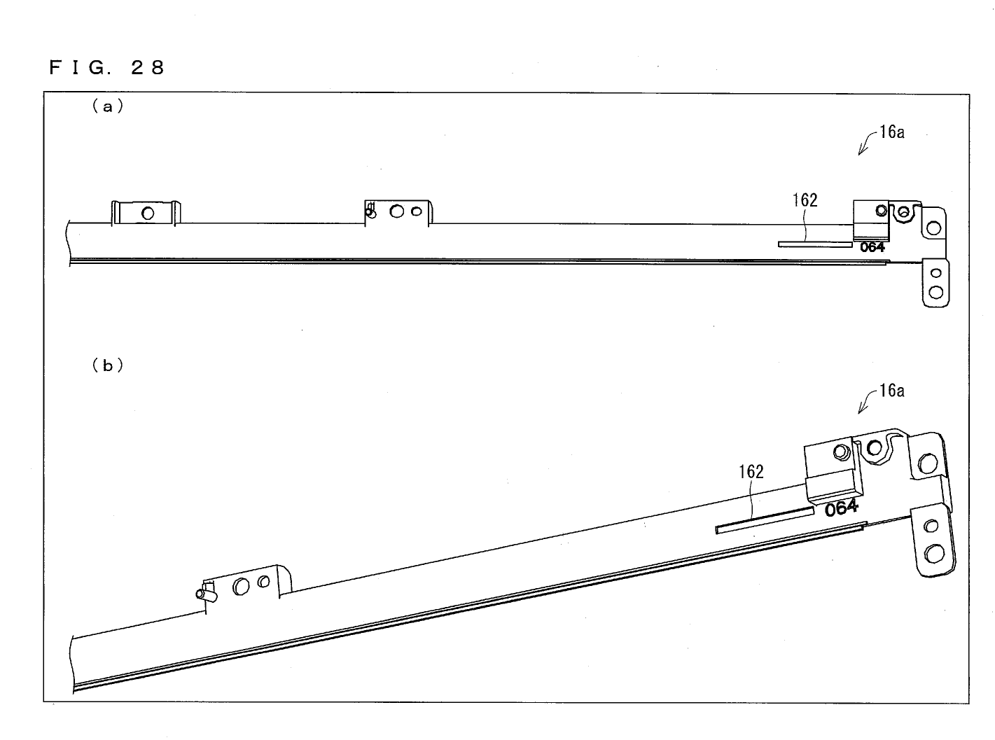

As described above, the optical sheet group 17 is held by the back cabinet 24 and the P chassis 16. The following discusses the P chassis 16 in detail with reference to FIGS. 28 through 30.

FIG. 28 is enlarged views each partially illustrating an appearance of an upper P chassis 16a of the P chassis 16 according to the present embodiment, wherein the upper P chassis 16a is provided on an upper portion of the back cabinet 24 as viewed from the front cabinet 10 side. (a) of FIG. 28 is a front view illustrating the upper P chassis 16a, and (b) of FIG. 28 is a perspective view illustrating the upper P chassis 16a.

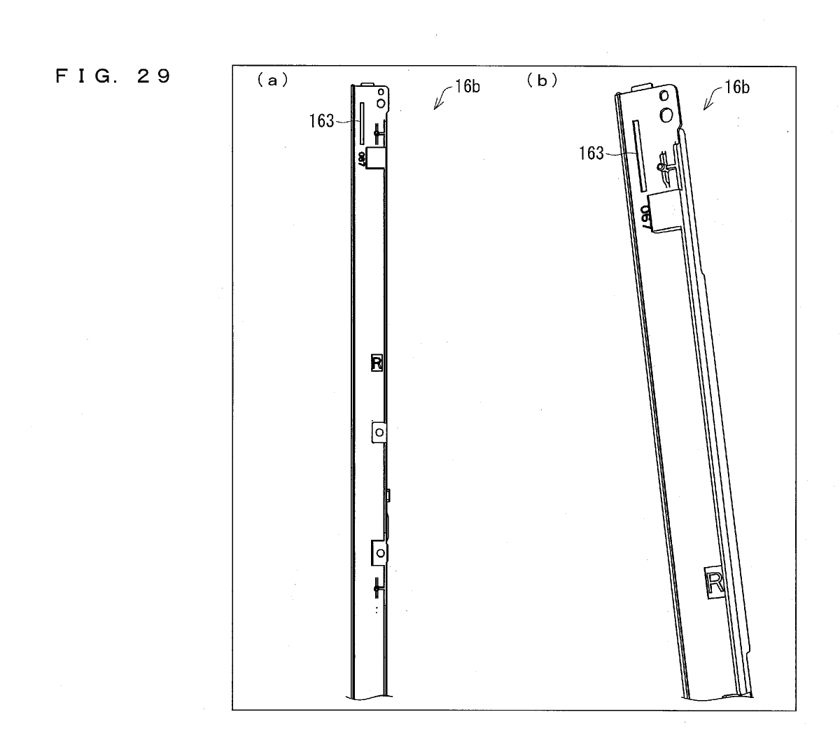

FIG. 29 is enlarged views each partially illustrating an appearance of a right P chassis 16b of the P chassis 16 according to the present embodiment, wherein the right P chassis 16b is provided on a right portion of the back cabinet 24 as viewed from the front cabinet 10 side. (a) of FIG. 29 is a front view illustrating the right P chassis 16b, and (b) of FIG. 29 is a perspective view illustrating the right P chassis 16b.

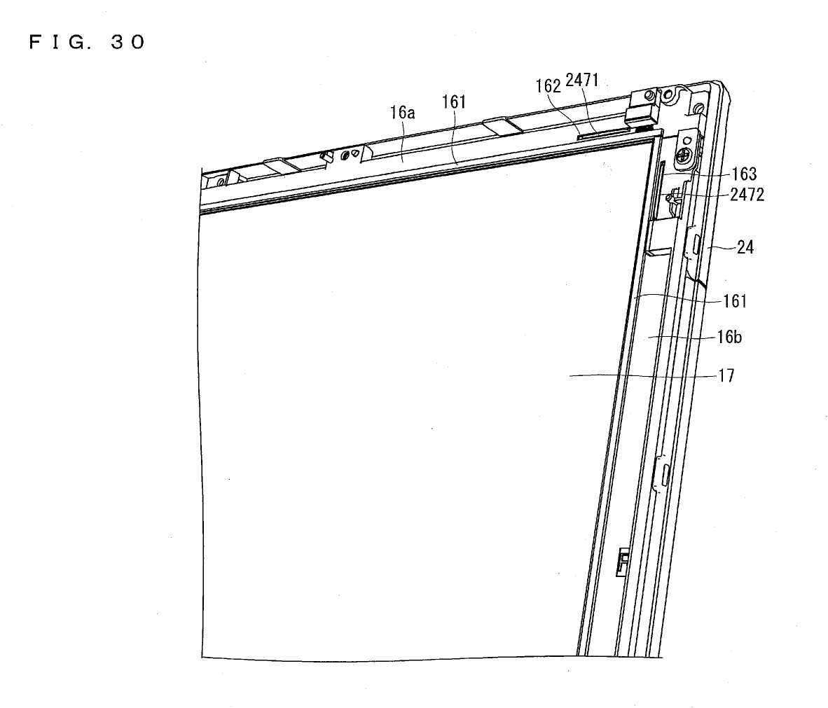

FIG. 30 is an enlarged perspective view partially illustrating the back cabinet 24, the optical sheet group 17, and the P chassis 16 according to the present embodiment.

The upper P chassis 16a has an opening 162 into which the protruding rib 2471 of the back cabinet 24 is to be inserted. The opening 162 is provided at a position corresponding to the protruding rib 2471 (see FIG. 28). The right P chassis 16b has an opening 163 into which the protruding rib 2472 of the back cabinet 24 is to be inserted. The opening 163 is provided at a position corresponding to the protruding rib 2472 (see FIG. 29).

As illustrated in FIG. 30, the upper P chassis 16a is provided so that the protruding rib 2471 is inserted into the opening 162, and the right P chassis 16b is provided so that the protruding rib 2472 is inserted into the opening 163. As such, the position of the P chassis 16 is fixed in the direction vertical to the normal direction of the back cabinet 24. Further, the P chassis 16, together with the back cabinet 24, hold the optical sheet group 17, thereby fixing the position of the optical sheet group 17 in the normal direction of the back cabinet 24.

According to the above arrangement, the display device 1 of the present embodiment is arranged such that the protruding rib 2471 is inserted into the opening 171 of the optical sheet group 17 and the opening 162 of the P chassis 16. This makes it possible to accurately fix the optical sheet group 17 and the P chassis 16 with respect to the back cabinet 24.

Note that in the present embodiment, the protruding ribs 2471 and 2472 of the back cabinet 24 are provided on an outward side with respect to the inner rib 2451 provided on the back cabinet 24 and on an inward side with respect to the outer rib 2452. That is, the openings 162 and 163 respectively corresponding to the protruding ribs 2471 and 2472 are provided farther away from the center of the display device 1 than the Poron 161 provided on the P chassis 16. This arrangement makes it possible to prevent interference between the protruding ribs 2471, 2472 of the back cabinet 24 and the Poron 161 of the P chassis 16.

In the present embodiment, each of the openings 171 of the optical sheet group 17 is long and narrow and extends along a corresponding one of four sides of the optical sheet group 17 which corresponding one of the four sides is closest to each of the openings 171 (see FIGS. 27 and 30). A cross section of a portion of the protruding rib 2471, which portion is to be inserted into the opening 171, and the opening 162 of the P chassis 16 have the same shape as the opening 171 of the optical sheet group 17.

This makes it possible to minimize influence which the opening 171 of the optical sheet group 17, the opening 162 of the P chassis 16, and the protruding rib 2471 exert on light emitted by the LED element 220 (that is, light to be used for display of an image on the display device 1).

Alternatively, the openings 171 can be provided along only an upper outer edge of the optical sheet group 17, and the notches 172 can be provided along a right-hand part, a left-hand part, and a bottom part of an outer edge of the optical sheet group 17. This arrangement makes it easier to attach the optical sheet group 17 to the back cabinet 24.

[Join of Back Cabinet and P Chassis]

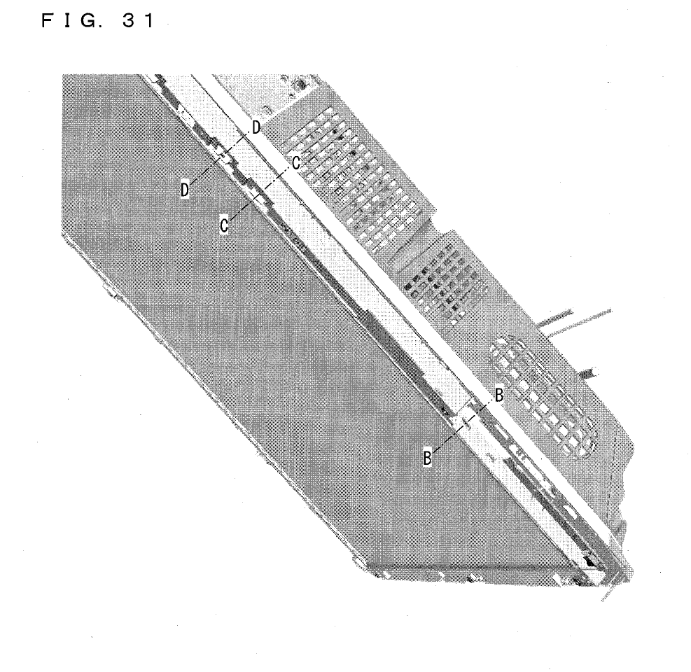

Next, the following discusses a structure to join the back cabinet 24 and the P chassis 16 with reference to FIGS. 31 through 34.

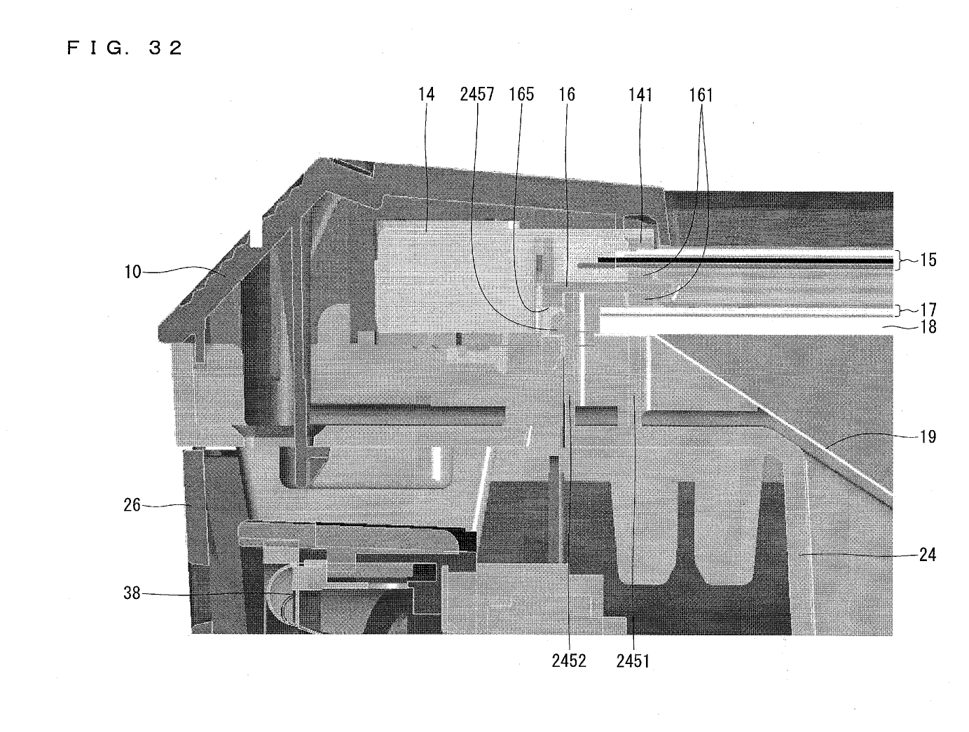

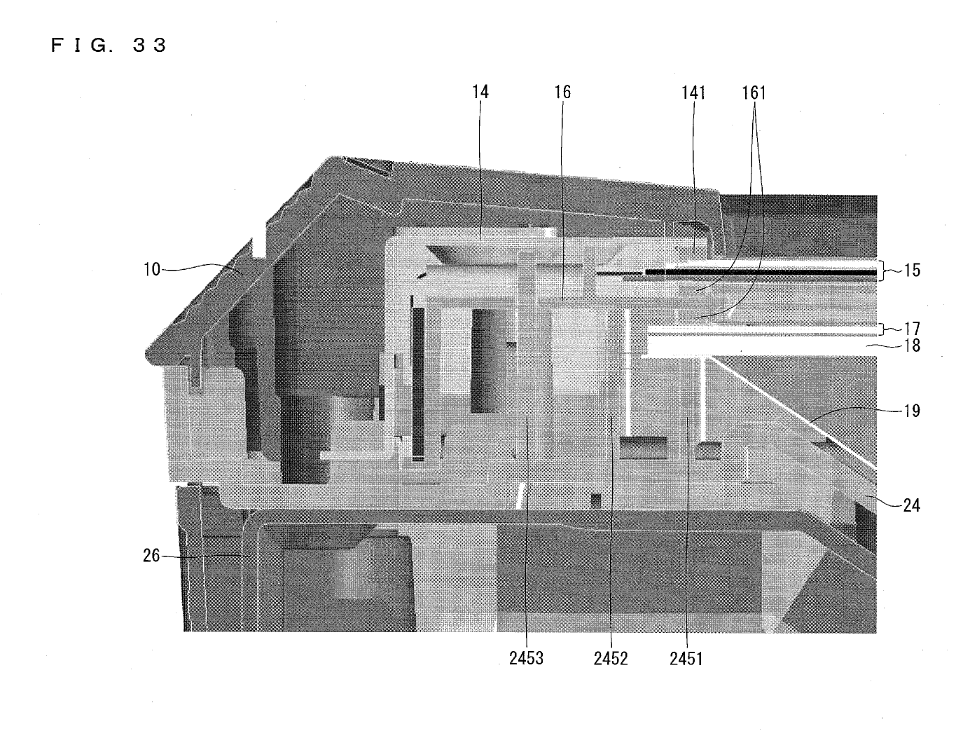

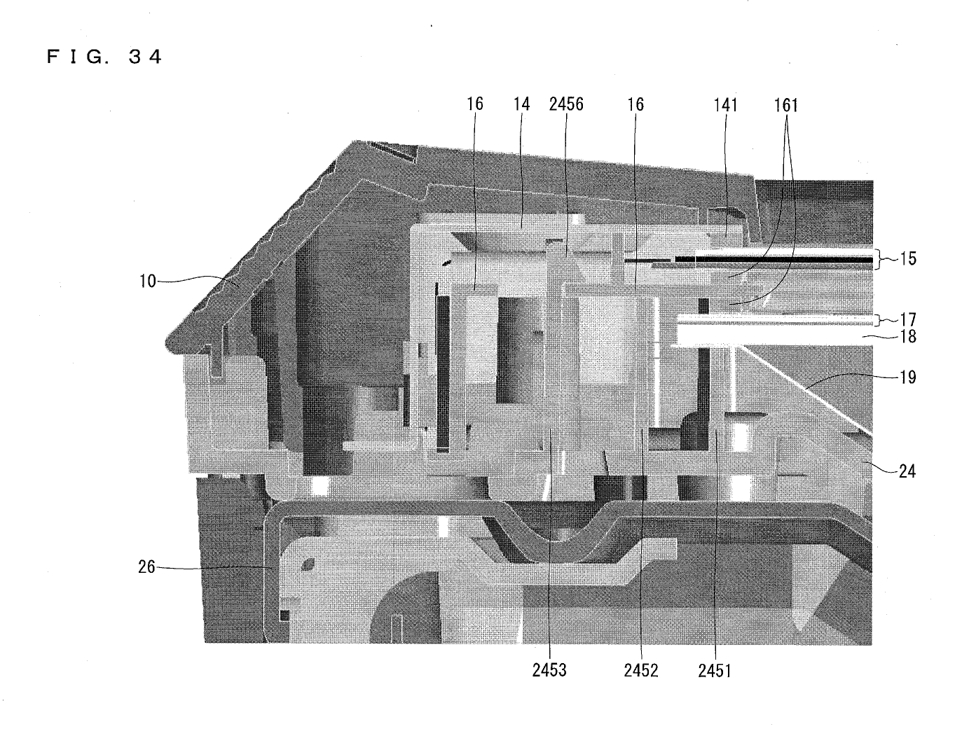

FIG. 31 is a perspective view illustrating the display device 1 according to the present embodiment, as viewed from a lower side of the display device 1. FIG. 32 is a cross-sectional view illustrating the display device 1 as taken along a line B-B illustrated in FIG. 31. FIG. 33 is a cross-sectional view illustrating the display device 1 as taken along a line C-C illustrated in FIG. 31. FIG. 34 is a cross-sectional view illustrating the display device 1 as taken along a line D-D illustrated in FIG. 31.

(Structure for Joining Back Cabinet and P Chassis)

As illustrated in FIG. 32, the outer rib 2452 has a tab portion 2457 provided on an outward side, with respect to the outside the outer rib 2452, as viewed from the center of the display device 1. Further, the P chassis 16 has a fitting portion 165 for fitting with the tab portion 2457. This makes it easy to join the P chassis 16 to the back cabinet 24, and thus it is possible to reduce parts such as, for example, screws which have conventionally been used to join the P chassis 16 to the back cabinet 24. Therefore, it is possible to (i) increase efficiency in attaching (assembling) the P chassis 16 to the back cabinet 24 and detaching the P chassis 16 from the back cabinet 24 (i.e., to simplify an assembly process and a detaching process), and to (ii) reduce costs for screws.

Further, the back cabinet 24 has a fixing boss 2453, provided in outward side with respect to the outer rib 2452, for fixing the P chassis 16 (see FIG. 33). The fixing boss 2453 has a fixing tab portion 2456 for fixing the P chassis 16 (see FIG. 34). This arrangement makes it possible to more firmly fix the P chassis 16 to the back cabinet 24, and therefore it is possible to further reduce parts required to join the P chassis 16 to the back cabinet 24.

[Structure for Fitting Front Cabinet and Back Cabinet]

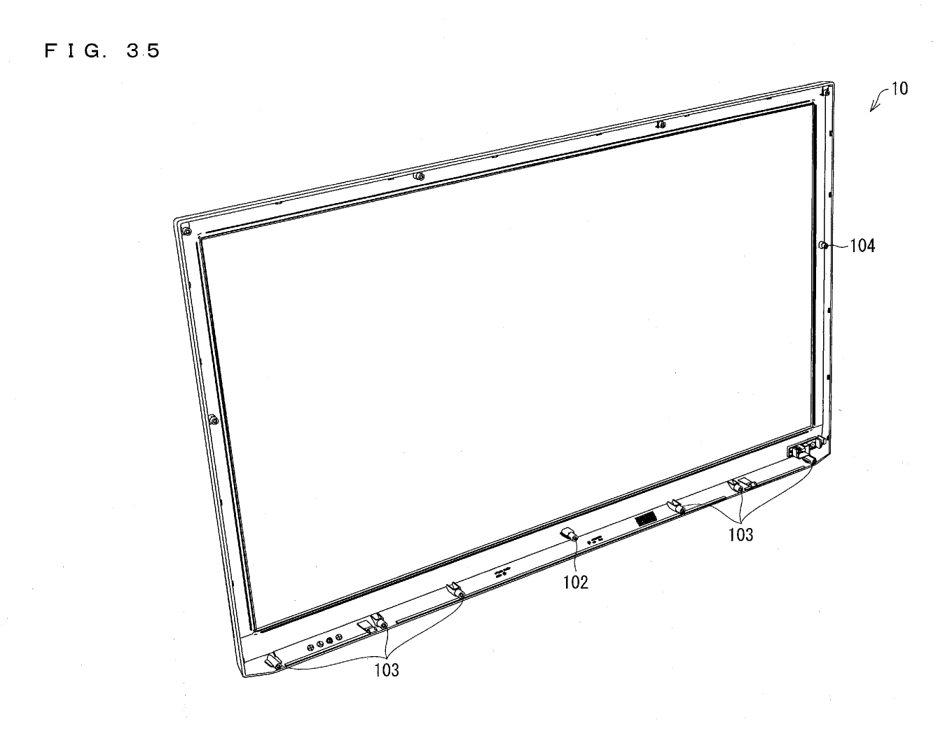

The following discusses in detail structures of the front cabinet 10, the back cabinet 24, the P chassis 16, and the bezel 14 for joining the front cabinet 10 to the back cabinet 24, with reference to FIGS. 35 through 39.

(Front Cabinet)

First, the structure of the front cabinet 10 is discussed below with reference to FIG. 35. FIG. 35 is a perspective view illustrating a back surface of the front cabinet 10 according to the present embodiment.

The front cabinet 10 has a plurality of bosses 102 through 104, provided on the back surface thereof (a surface on which the liquid crystal panel 15 and the like are to be provided), for joining the front cabinet 10 to the back cabinet 24 (see FIG. 35). The boss 102 (fixing boss) and the bosses 103 are provided on a lower side of the back surface of the front cabinet 10, and the boss 104 is provided on a right side of the back surface of the front cabinet 10. Note that the front cabinet 10 also has bosses on an upper side of the back surface thereof and a left side of the back surface thereof, although the descriptions of such members are omitted here.

Further, the boss 102 is provided so as to be closer to the center of the display device 1 than the bosses 103. This can prevent a lower section of the front cabinet 10 from bending toward a front side of the display device 1 due to its weight, and thus prevents the front cabinet 10 and the liquid crystal panel 15 from being detached from each other.

(Back Cabinet)

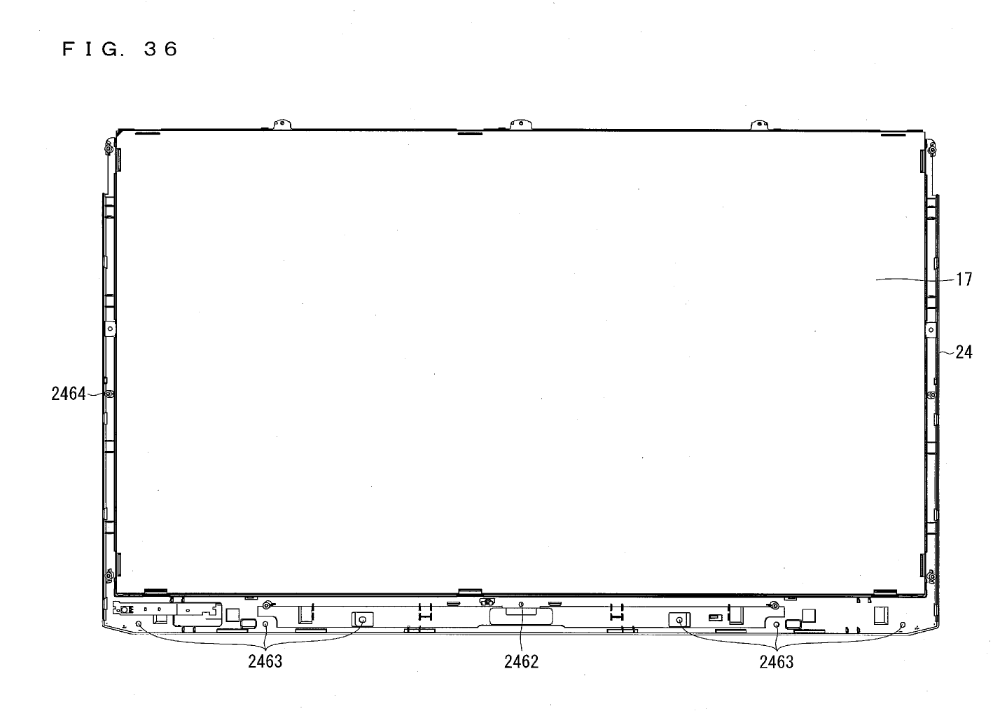

Next, the arrangement of the back cabinet 24 is discussed below with reference to FIG. 36. FIG. 36 is a front view illustrating a state in which the optical sheet group 17 is provided on the back cabinet 24 according to the present embodiment.

The back cabinet 24 has fitting portions 2462 through 2464 for causing the bosses 102 through 104 of the front cabinet 10 to fit into the fitting portions 2462 through 2464 (see FIG. 36). The fitting portion 2462 is provided so as to be closer to the center of the display device 1 than the fitting portions 24633 so that the boss 102 is fit into the fitting portion 2462. Note that the back cabinet 24 also has fitting portions on an upper side and a left side thereof, but the descriptions of such members are omitted here as with the case of the front cabinet 10.

(P Chassis and Bezel)

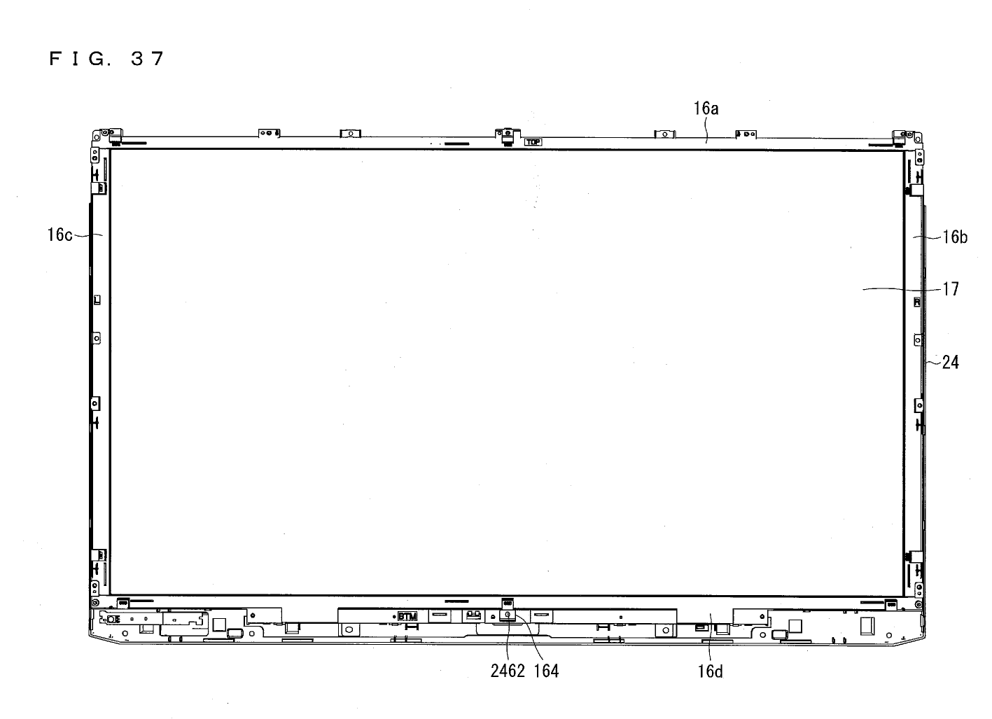

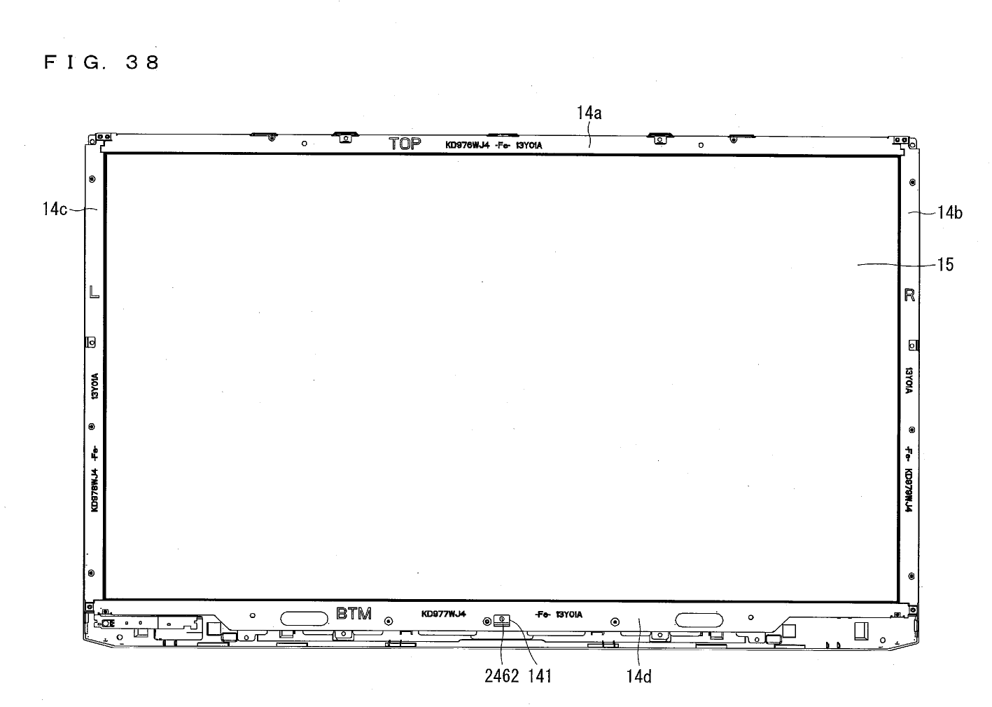

Next, the following discusses the arrangements of the P chassis 16 and the bezel 14 with reference to FIGS. 37 and 38. FIG. 37 is a front view illustrating a state in which the optical sheet group 17 and the P chassis 16 are provided on the back cabinet 24 according to the present embodiment. FIG. 38 is a front view illustrating a state in which the optical sheet group 17, the P chassis 16, the liquid crystal panel 15, and the bezel 14 are provided on the back cabinet 24 according to the present embodiment.

As illustrated in FIG. 37, the display device 1 of the present embodiment is arranged such that the P chassis 16 is provided on the back cabinet 24. More specifically, (i) the upper P chassis 16a is provided on the upper side of the back cabinet 24, (ii) the right P chassis 16b is provided on the right side of the back cabinet 24, (iii) a left P chassis 16c is provided on the left side of the back cabinet 24, and (iv) a lower chassis 16d is provided on a lower side of the back cabinet 24.

The P chassis 16 is arranged such that, in a case where the P chassis 16 is provided on the back cabinet 24, the fitting portions 2462 through 2464 are exposed from the back cabinet 24 as viewed from the front cabinet 10 side (see FIG. 37).

For example, a through hole 164 from which the fitting portion 2462 of the back cabinet 24 is exposed is provided near a center of the lower P chassis 16d (see FIG. 37). In other words, the through hole 164 through which the boss 102 of the front cabinet 102 pierces is provided near the center of the lower P chassis 16d.

As illustrated in FIG. 38, the display device 1 according to the present embodiment is arranged such that the bezel 14 is provided on the liquid crystal panel 15 which is provided on a stack of the P chassis 16 and the back cabinet 24. More specifically, (i) an upper bezel 14a is provided on the upper side of the back cabinet 24, (ii) a right bezel 14b is provided on the right side of the back cabinet 24, (iii) a left bezel 14c is provided on the left side of the back cabinet 24, and (iv) a lower bezel 14d is provided on the lower side of the back cabinet 24.

As illustrated in FIG. 38, the bezel 14 is arranged such that, in a case where the bezel 14 is provided on the back cabinet 24, the fitting portions 2462 through 2464 are exposed from the back cabinet 24 as viewed from the front cabinet 10 side.

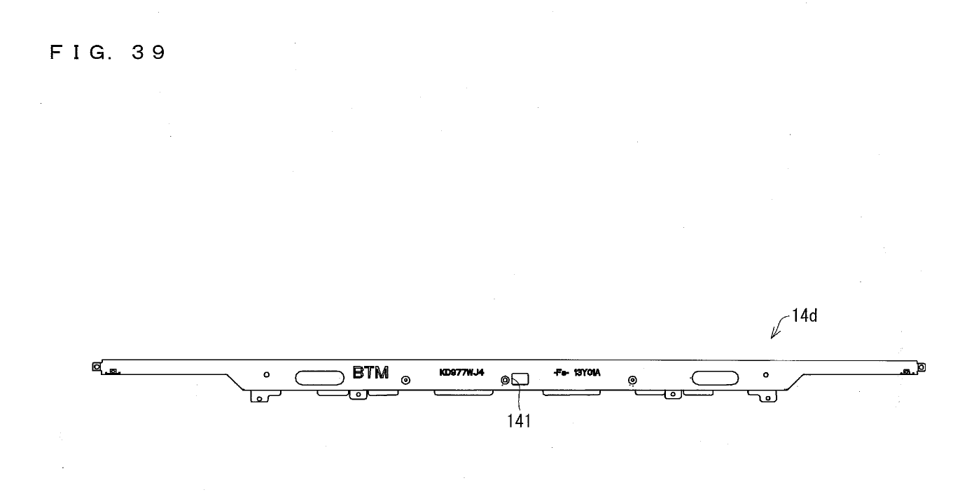

Here, the lower bezel 14d is discussed in detail with reference to FIG. 39. FIG. 39 is a front view illustrating an appearance of the lower bezel 14d according to the present embodiment.

As illustrated in FIG. 39, a through hole 141 from which the fitting portion 2462 of the back cabinet 24 is exposed is provided near a center of the lower bezel 14d. In other words, the through hole 141 through which the boss 102 of the front cabinet 10 pierces is provided near the center of the lower bezel 14d.

As such, the lower P chassis 16d and the lower bezel 14d have the through holes 164 and 141, respectively, so that the boss 102 of the front cabinet 10 and the fitting portion 2562 of the back cabinet 24 can directly fit to each other without making contact with the lower P chassis 16d and the lower bezel 14d.

This makes it possible to prevent stress, which occurs when the front cabinet 10 is attached to the back cabinet 24, from being propagated to the liquid crystal panel 15 through the lower P chassis 16d and the lower bezel 14d. Thus, the stress, which occurs when the front cabinet 10 is attached to the back cabinet 24, is not locally applied to the liquid crystal panel 15. This makes it possible to prevent local variation in display performance (e.g., luminance unevenness) of the liquid crystal panel 15.

In the present embodiment, the boss 102 of the front cabinet 10 has a substantially columnar cross section (see FIG. 35). The through hole 164 of the lower P chassis 16d and the through hole 141 of the lower bezel 14d each are a substantially rectangular in shape and have a short side longer than a diameter of the boss 102 (see FIGS. 37 and 38). This makes it possible to (i) decrease deterioration of the front cabinet 10, the lower P chassis 16d, and the lower bezel 14d due to interference between the boss 102 and the through holes 164 and 141, and to (ii) increase efficiency in assembly process and removing process.

(Join of Front Cabinet and Back Cabinet with Tab)

In the present embodiment, a tab portion 2455 for simply fixing the front cabinet 10 is provided on the outer edge of the back cabinet 24 (see FIG. 26). Further, an engaging portion 101 for fitting to the tab portion 2455 is provided on the front cabinet 10.

The above arrangement increases efficiency in attaching and detaching the front cabinet 10 and the back cabinet 24. Further, it is possible to reduce the number of components related to engagement between the back cabinet 24 and the front cabinet 10 (e.g., screws and the like). This makes it possible to reduce costs for the engagement-related components.

[Recap]

A direct backlight according to Aspect 1 of the present invention includes: a substrate (LED substrate 22) having a plurality of light sources (LED elements 220) provided thereon; an optical member (light diffusing plate 18) being provided at such a position as to face the light sources; and a supporting pole (clip 20), fixed in between each adjacent two of the light sources on the substrate, for supporting the optical member, the supporting pole having light transparency, the supporting pole having two surfaces which respectively face the each adjacent two of the light sources and at least part of which are mirror-finished.

According to the above arrangement, (i) a shadow cast by the supporting pole which blocks light emitted from one of the light sources, and (ii) reflection light produced by the supporting pole reflecting light emitted from another one of the light sources overlap each other on an optical member. However, the shadow is less intense due to light transparency of the supporting pole, while the reflection light is more intense since the supporting pole includes two surfaces at least some region of which are mirror-finished and which respectively face each two light sources. Thus, the shadow and the reflection light are cancelled out by each other. This makes it possible to reduce shadow cast on the optical member.

As such, with use of the supporting pole having light transparency and including two surfaces at least some region of which are mirror-finished and which respectively face light sources provided on both sides of the supporting pole. This makes it possible to reduce shadow cast on the optical member by the supporting pole.

A direct backlight according to Aspect 2 of the present invention may be arranged, in Aspect 1 above, such that the supporting pole is fixed to the substrate by being caused to penetrate the substrate and being twisted.

According to the above arrangement, the supporting pole is attached to the substrate by a simple process. This makes it easy to reuse the supporting pole and to disassemble and dismantle the direct backlight (or a direct backlight).

A direct backlight according to Aspect 3 of the present invention may be arranged, in Aspect 2 above, such that the supporting pole includes: (i) a through portion (203) which reaches an opposite side of the substrate in a case where the supporting pole is caused to penetrate the substrate; and (ii) a catch portion (202) for holding, together with the through portion, the substrate therebetween in a case where the supporting pole is inserted through the substrate and twisted.

According to the above arrangement, the through portion functions like an anchor, and the through portion, together with the catch portion, holds the substrate therebetween. This makes it possible to fix the supporting pole to the substrate.

A direct backlight according to Aspect 4 of the present invention may be arranged, in any one of Aspects 1 through 3 above, such that a reflection sheet (19) is provided between the substrate and the plurality of light sources, and the supporting pole, together with the substrate, holds the reflection sheet therebetween.

According to the above arrangement, the supporting pole fixes the reflection sheet as well. This makes it possible to simplify an assembly process.

A direct backlight according to Aspect 5 of the present invention may be arranged, in any one of Aspects 1 through 4 above, such that the supporting pole includes a columnar portion (201) that serves as a base of the mirror-finished part (flat plate portion 200).

The above arrangement makes it possible to support the mirror-finished part having low strength, thus enabling enhancement in strength of the whole clip 20.

A television receiver according to Aspect 6 of the present invention includes the direct backlight recited in any one of Aspects 1 through 5.

According to the above arrangement, the television receiver yields the same effect as the effect yielded by any one of Aspects 1 through 5.

The present invention is not limited to the embodiments, but can be altered by a skilled person in the art within the scope of the claims. An embodiment derived from a proper combination of technical means each disclosed in a different embodiment is also encompassed in the technical scope of the present invention.

### INDUSTRIAL APPLICABILITY

The present invention is applicable to (i) a general display device including a television receiver and (ii) a backlight of the display device.

### REFERENCE SIGNS LIST

1 Display Device
10 Front Cabinet
101 Engaging Portion
102 Boss
103, 104 Boss
14 Bezel
141 Through Hole
15 Liquid Crystal Panel (Display Panel)
16 P Chassis (Chassis)
161 Poron (Cushioning Member)
162 Opening
163 Opening
164 Through Hole
165 Fitting Portion
17 Optical Sheet Group (Optical Sheet)
171 Opening
172 Notch
18 Light Diffusing Plate (Optical Member)
19 Reflection Sheet
20 Clip (Supporting Pole)
22 LED Substrate (Substrate)
220 LED Element
221 Connecter
222 Notch (First Notch)
223 Notch (Second Notch)
224 Opening
225 Opening
226 Notch
23 Heat Spreader (Heat Dissipating Plate)
23a Lateral Surfaces
23b Bottom Surface
231 Opening
232 Opening
233 Opening
24 Back Cabinet
240 Fixing Rib
2400 Rib (Fixing Rib, First Protrusion)
2401 Rib (Fixing Rib, Substrate Supporting Rib)
2401a Protrusion (Second Protrusion)
2401b Supporting Portion
2402 Rib (Fixing Rib, Substrate Supporting Rib)
2403 Rib (Fixing Rib, Substrate Supporting Rib)
2403a Groove
2403b Covering Portion (Holding Portion)
2403c Supporting Section (Holding Portion)
2404 Rib (Fixing Rib)
2404a Pressing Portion
2404b Insertion Portion
2410 Structure
2411 Rib
2451 Inner Rib (Rib, Inner Rib)
2452 Outer Rib (Rib, Outer Rib)
2453 Fixing Boss
2454 Notch
2455 Tab Portion (Tab)
2456 Fixing Tab Portion
2457 Tab Portion (Fitting Portion)
2462 through 2464 Fitting Portions
2471 Protruding Rib
2472 Protruding Rib
28 Main Circuit
29 Power Source Circuit

1.-6. (canceled)

7. A direct backlight comprising:
a substrate having a plurality of light sources provided thereon;
an optical member being provided at such a position as to face the light sources; and
a supporting pole, fixed in between each adjacent two of the light sources on the substrate, for supporting the optical member,
the supporting pole having light transparency,
the supporting pole including two surfaces at least some region of which are mirror-finished and which respectively face the each adjacent two of the light sources.

8. The direct backlight according to claim 7, wherein
the supporting pole is fixed to the substrate by being caused to penetrate the substrate and being twisted.

9. The direct backlight according to claim 8, wherein
the supporting pole includes: (i) a through portion which reaches an opposite side of the substrate in a case where the supporting pole is caused to penetrate the substrate; and (ii) a catch portion for holding, together with the through portion, the substrate therebetween in a case where the supporting pole is inserted through the substrate and twisted.

10. The direct backlight according to claim 7, wherein
a reflection sheet is provided between the substrate and the plurality of light sources, and
the supporting pole, together with the substrate, holds the reflection sheet therebetween.

11. The direct backlight according to claim 7, wherein
the supporting pole includes a columnar portion that serves as a base of the mirror-finished part.

12. The direct backlight according to claim 7, wherein
the supporting pole includes (i) a flat plate portion being mirror-finished and (ii) a columnar portion serving as a base of the flat plate portion.

13. The direct backlight according to claim 7, wherein
the supporting pole includes a flat plate portion in a shape of a flat plate, the flat plate portion having the two surfaces being mirror-finished and being flat surfaces.

14. A television receiver comprising the direct backlight recited in claim 7.
